(19) United States
(12) Patent Application Publication
(10) Pub. No.: US 2021/0061601 A1
(43) Pub. Date: Mar. 4, 2021

(54) CONVEYOR

(71) Applicant: Konica Minolta, Inc., Tokyo (JP)

(72) Inventors: Toshikazu HIGASHI, Toyokawa-shi (JP); Tatsuya EGUCHI, Toyohashi-shi (JP); Takashi WATANABE, Toyokawa-shi (JP); Shigetaka KATO, Shinshiro-shi (JP); Takeshi ISHIDA, Toyohashi-shi (JP)

(21) Appl. No.: 17/010,306

(22) Filed: Sep. 2, 2020

(30) Foreign Application Priority Data
Sep. 3, 2019 (JP) 2019-160089

(51) Int. Cl. B65H 7/12; B41F 33/02; G01S 15/10

(52) U.S. Cl. CPC B65H 7/125; B65H 2553/30; G01S 15/101; B41F 33/02

(57) ABSTRACT

A conveyor conveys a sheet along a conveyance path provided with an ultrasonic sensor, and includes: an updating member that successively updates a parameter indicating aged deterioration of the conveyor; a searcher that searches a look-up table storing pieces of noise data of noises predicted to be superimposed on a detection signal of the ultrasonic sensor in accordance with a degree of the aged deterioration, and obtains a piece of noise data corresponding to a current parameter value of the conveyor; and a signal processor that uses, for signal processing, a remaining portion of the detection signal of the ultrasonic sensor excluding a portion corresponding to the piece of noise data obtained by the searcher.

### CROSS-REFERENCE TO RELATED APPLICATION

The present invention claims priority under 35 U.S.C. § 119 to Japanese Application No. 2019-160089, filed on Sep. 3, 2019, the entire content of which is incorporated herein by reference.

### BACKGROUND

### Technological Field

The present invention relates to a conveyor that conveys a sheet through a conveyance path provided with an ultrasonic sensor, and particularly, relates to improvement in signal processing applied to a detection signal detected by the ultrasonic sensor.

### Description of the Related Art

An ultrasonic sensor in the above-described conveyor includes a set of a transmission element and a reception element facing each other interposing a conveyance path therebetween. When an ultrasonic wave is transmitted during sheet conveyance in the conveyance path provided with the ultrasonic sensor, a detection signal output from the reception element of the ultrasonic sensor is attenuated due to passage of a conveyed object. That is, when a thickness of the conveyed object passing through the conveyance path is small, attenuation of the ultrasonic wave received by the reception element is small. Conversely, when the thickness of the conveyed object passing through the conveyance path is large, the attenuation of the ultrasonic wave received by the reception element is large. A conventional conveyor executes, on the basis of such an attenuation amount of a peak value appearing in a detection signal, discrimination between whether a conveyed object passing through a conveyance path is a single sheet without overlapping or includes two or more sheets overlapping with each other (double feed determination).

Examples of an image forming apparatus that performs the double feed determination in signal processing using an ultrasonic sensor include JP 2005-15121 A and JP 6-229787 A.

A transmission element and a reception element are installed in an inclined posture in a housing or a frame of an image forming apparatus so as to elongate a path of ultrasonic waves passing through sheets. While the housing or the frame maintains robustness, the reception element stably keeps the inclined posture, but when the housing or the frame comes to lose the robustness in a latter stage of durability, the reception element loses the stability and becomes gradually affected by vibration and impact from a roller or a guide plate existing in a periphery of the reception element.

A noise caused by the vibration spreads over a wide frequency band, and there may be a noise generated at a resonance frequency of the reception element. The noise generated at such a resonance frequency cannot be removed by a bandpass filter or the like disclosed in a conventional technology. As described above, the conventional technology does not have a technique to suppress the noise caused by decrease in the robustness of the housing or the frame due to approach to the latter stage of durability, and there is a problem that accuracy of the double feed determination is deteriorated in the latter stage of durability and various troubles relating to sheet conveyance may be caused.

Note that, recently, an ultrasonic sensor is adopted not only for the double feed determination but also for sheet type determination. As far as attenuation of ultrasonic waves at the time of sheet passage is utilized, the sheet type determination may also have a problem of the above-described determination accuracy in the latter stage of durability, and there is a problem that a manufacturer having developed a conveyor may be plagued by such accuracy deterioration in the double feed determination and the sheet type determination.

Additionally, the case of utilizing the ultrasonic sensor in which the transmission element and the reception element face each other while interposing the conveyance path therebetween has been exemplified, but not limited thereto. Even in a case of utilizing, for the double feed determination, an ultrasonic sensor (reflective ultrasonic sensor) in which a transmission element and a reception element are arranged on one side of a conveyance path and a reflected wave of an ultrasonic wave transmitted from the transmission element is received therein, there also is the problem of deterioration of determination accuracy as described above.

### SUMMARY

An object of the present invention is to provide a conveyor capable of maintaining a reasonable level of accuracy in determination processing using an attenuation degree of a detection signal of an ultrasonic sensor even though a noise signal caused by vibration and impact is superimposed on the detection signal output from the ultrasonic sensor.

To achieve the abovementioned object, according to an aspect of the present invention, there is provided a conveyor that conveys a sheet along a conveyance path provided with an ultrasonic sensor, and the conveyor reflecting one aspect of the present invention comprises: an updating member that successively updates a parameter indicating aged deterioration of the conveyor; a searcher that searches a look-up table storing pieces of noise data of noises predicted to be superimposed on a detection signal of the ultrasonic sensor in accordance with a degree of the aged deterioration, and obtains a piece of noise data corresponding to a current parameter value of the conveyor; and a signal processor that uses, for signal processing, a remaining portion of the detection signal of the ultrasonic sensor excluding a portion corresponding to the piece of noise data obtained by the searcher.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating an external view of an image forming apparatus according to an embodiment;

FIG. 2 is a block diagram illustrating functional components of the image forming apparatus;

FIG. 3 illustrates a conveyance path and conveyance members provided thereon;

FIG. 4 is a block diagram illustrating internal components of an ultrasonic sensor and a signal processor;

FIG. 5A illustrates internal components of a database;

FIG. 5B illustrates a noise increase tendency in an early stage of durability and a latter stage of durability;

FIG. 6A and FIG. 6B are timing charts illustrating drive commands of a mechanical controller in a first phase of the latter stage of durability and a detection signal from the ultrasonic sensor;

FIG. 6C illustrates pieces of discrete sampling data obtained by quantization by an AD converter;

FIG. 7A illustrates a detection signal on which noises are superimposed in the early stage of durability;

FIG. 7B illustrates a detection signal on which noises are superimposed in the latter stage of durability;

FIG. 8 is a flowchart of apparatus noise prevention processing performed by the signal processor;

FIG. 9A to FIG. 9D illustrate processing processes performed by the AD converter and a sampling data processor;

FIG. 10A illustrates pieces of sampling data to be removed from a detection signal;

FIG. 10B illustrates a discretized signal waveform after the pieces of sampling data corresponding to noises are removed;

FIG. 11 illustrates an error screen that displays a message indicating that occurrence of sheet double feed cannot be correctly determined;

FIG. 12A illustrates an exemplary data structure of reference waveform data;

FIG. 12B illustrates an exemplary waveform shape of the reference waveform data;

FIG. 13 is a flowchart illustrating a processing procedure of a self-evaluator;

FIG. 14A illustrates an exemplary waveform shape of a detection signal;

FIG. 14B illustrates a signal waveform multiplied by a rate a greater than 1;

FIG. 14C illustrates a signal waveform multiplied by a rate 13 smaller than 1;

FIG. 15A and FIG. 15B are flowcharts each illustrating a setting procedure of an execution mode used to set whether or not to execute a factor-identifying operation;

FIG. 16 is a flowchart illustrating a processing procedure of the self-evaluator in accordance with the setting of the execution mode;

FIG. 17A illustrates reference waveform data at the time of having no transmission of ultrasonic waves;

FIG. 17B illustrates an exemplary increase tendency look-up table at the time of having no transmission of ultrasonic waves;

FIG. 18A is a timing chart in a case of executing the factor-identifying operation during sheet feeding;

FIG. 18B is a timing chart in a case of executing the factor-identifying operation during no sheet feeding;

FIG. 19 is a timing chart illustrating clutch on/off timing of a vertical conveyance roller; and

FIG. 20 illustrates internal components of an automatic document feeder illustrated in FIG. 1.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

Hereinafter, an embodiment of an image forming apparatus including a conveyor according to the present invention will be described by using a multi-function printer (MFP) as an example.

### [1] External View of Image Forming Apparatus 1000

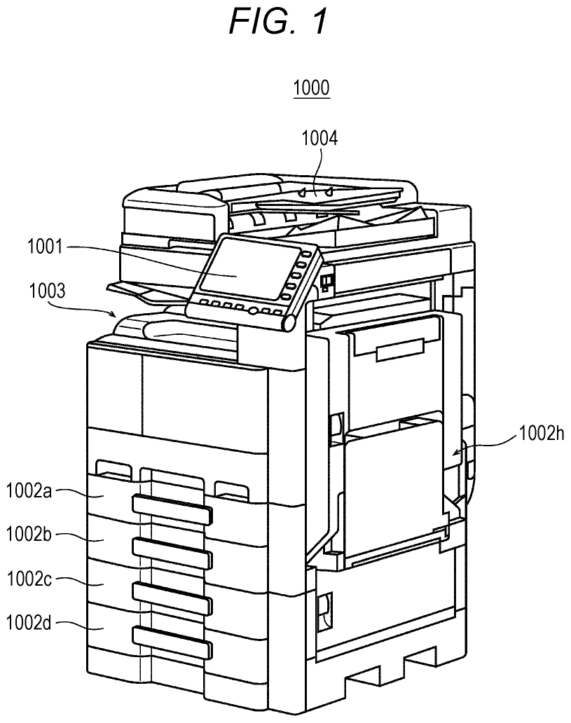

FIG. 1 is a view illustrating an external view of an image forming apparatus 1000 that is an MFP.

The image forming apparatus 1000 feeds, in accordance with operation by a user made on a touch panel display 1001, sheets set on sheet feeding cassettes 1002a, 1002b, 1002c, and 1002d, and a manual feeding tray 1002h while forming images on each photoconductor, transfers a toner image that has been formed on each photoconductor to a sheet, and ejects the sheet to an ejection tray 1003. During the sheet feeding, the image forming apparatus 1000 performs: double feed determination to determine whether or not two or more sheets are fed in an overlapping manner from the sheet feeding cassettes 1002a, 1002b, 1002c, and 1002d, and the manual feeding tray 1002h; and sheet type determination to determine a sheet type of each fed sheet. Note that, since it becomes complicated to describe both the double feed determination and the sheet type determination, a description will be provided for a case where the image forming apparatus 1000 executes the double feed determination.

### [2] Functional Configurations of Image Forming Apparatus

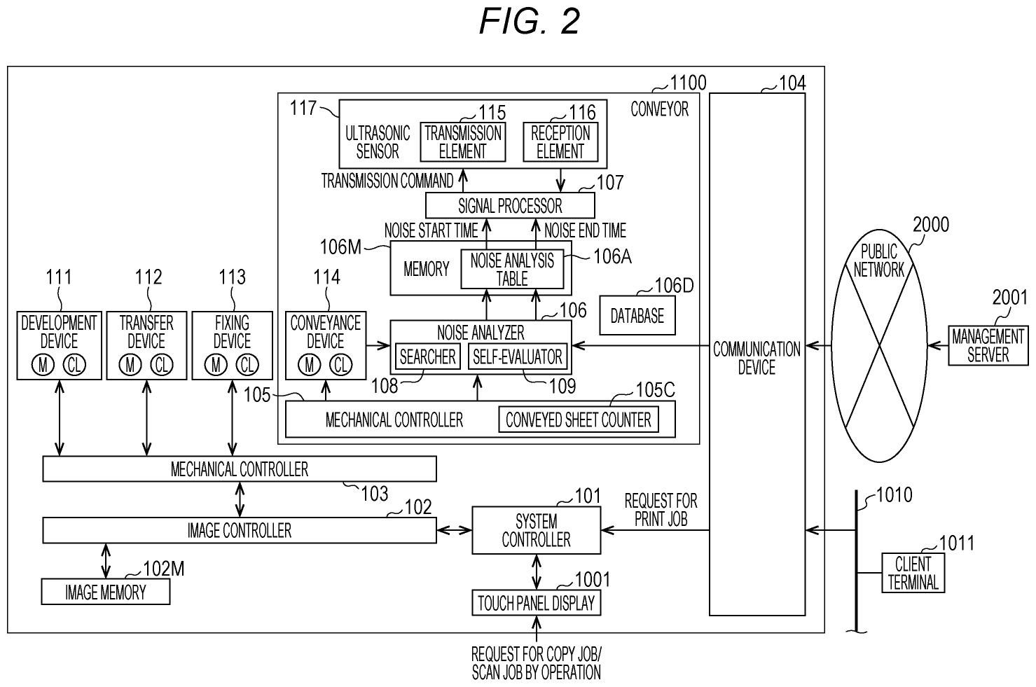

FIG. 2 illustrates functional components of the image forming apparatus 1000. As illustrated in this drawing, the image forming apparatus 1000 includes a system controller 101, an image controller 102, a mechanical controller 103, a communication device 104, a mechanical controller 105, a noise analyzer 106 (including a searcher 108 and a self-evaluator 109), a signal processor 107, a development device 111, a transfer device 112, a fixing device 113, a conveyance device 114, and an ultrasonic sensor 117 (including a transmission element 115 and a reception element 116). Among these components, the conveyor 1100 includes the mechanical controller 105, the noise analyzer 106, the signal processor 107, the conveyance device 114, and the ultrasonic sensor 117.

(2-1) System Controller 101

The system controller 101 generates and executes a copy job, a scan job, and a print job in accordance with: a request for a copy job and a request for a scan job made by a user operating on the touch panel display 1001 (see FIG. 1); and a request for a print job from a client terminal 1011 connected to a local area network. Additionally, the system controller 101 causes, in accordance with a determination result of the double feed determination by the signal processor 107, the touch panel display 1001 to display a message indicating that sheets are overlapping.

(2-2) Image Controller 102

The image controller 102 converts, into a print format, image data to be a target of a print job or image data optically read by an automatic document feeder 1004 (see FIG. 1), and writes the print format in an image memory 102M.

(2-3) Mechanical Controller 103

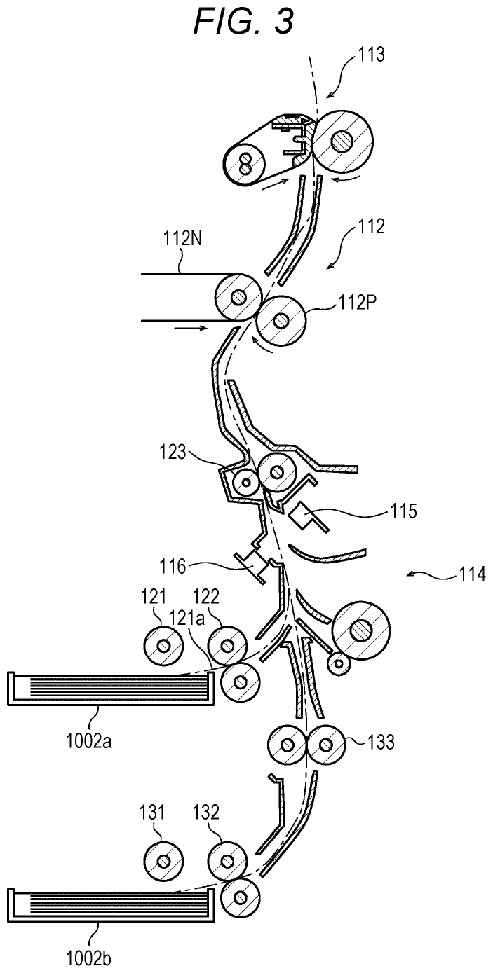

The mechanical controller 103 is used to print image data by controlling motors and clutches of the development device 111, the transfer device 112, and the fixing device 113. The development device 111 forms a toner image on each photoconductor under the control of the mechanical controller 103. Additionally, the transfer device 112 performs a primary transfer of the toner image formed on each photoconductor to an intermediate transfer belt 112N (see FIG. 3), and then transfers the toner image to a sheet that passes at a nip formed between the intermediate transfer belt 112N and a secondary transfer roller 112P (see FIG. 3) contacting the intermediate transfer belt at a secondary transfer position. The fixing device 113 heats and fixes the toner image that has been transferred to the sheet.

(2-4) Communication Device 104

The communication device 104 executes data transmission/reception with the client terminal 1011 connected to a local area network 1010 or a management server 2001 connected to a public network 2000. In this data transmission/reception, data received from the client terminal 1011 includes print job request data, and data received from the management server 2001 includes a database 106D.

(2-5) Mechanical Controller 105

The mechanical controller 105 controls the motor and the clutch of the conveyance device 114 to feed sheets from the sheet feeding cassettes 1002a and 1002b (see FIG. 1) to provide the sheets to the conveyance path. Additionally, when drive control of the motor and the clutch of the conveyance device 114 that may become a noise factor is executed, the mechanical controller 105 notifies the noise analyzer 106 of a code (factor code) that identifies the noise factor.

Furthermore, the mechanical controller 105 includes a counter (conveyed sheet counter 105C) that counts the total number of conveyed sheets after installation of the image forming apparatus 1000 in an office, and increments the number of conveyed sheets every time a sheet is conveyed through the conveyance path under the control of the mechanical controller 105. Such number of conveyed sheets has a causal relation with deterioration caused by long-term use of the conveyor 1100. Therefore, in the present embodiment, a count value by the conveyed sheet counter 105C is used as a parameter indicating a deterioration degree caused by the use of the conveyor 1100.

(2-6) Noise Analyzer 106

The noise analyzer 106 includes: the searcher 108 that requests, via the public network 2000, the management server 2001 to download the database 106D, and searches the database 106D; and the self-evaluator 109 that applies, to the database 106D downloaded, adjustment unique to own apparatus. The searcher 108 searches the database 106D while using, as search keys of: the current number of conveyed sheets counted by the conveyed sheet counter 105C; and the factor code notification of which is provided from the mechanical controller 105. Through the search, the current number of conveyed sheets and noise data of a noise according to the factor code are read from the database 106D, and a timepoint at which the noise appears on a detection signal of the ultrasonic sensor 117 and a timepoint at which the noise disappears are clarified by using this noise data. Then, start time and end time of a period during which the noise is superimposed are identified. Note that the self-evaluator 109 will be described in a second embodiment.

(2-7) Signal Processor 107

When a job is started, the signal processor 107 causes the transmission element 115 included in the ultrasonic sensor 117 to start transmission of ultrasonic waves. Then, when a sheet passes between the transmission element 115 and the reception element 116, an attenuation degree of the ultrasonic waves due to the passage of the sheet is calculated to perform the double feed determination. Furthermore, when the noise start time and the noise end time are clarified from the analysis by the noise analyzer 106, a signal portion corresponding to the period from the noise start time to the noise end time is removed from the detection signal output by the reception element 116 of the ultrasonic sensor 117.

### [3] Conveyance Path and Conveyance Member

FIG. 3 illustrates the conveyance path and conveyance members provided thereon.

Examples of the conveyance members include: a sheet feeding roller 122 that feeds a sheet fed from a first sheet feeding cassette 1002a to a conveyance path 121a by a pickup roller 121; a timing roller 123 that further feeds the sheet fed from the sheet feeding roller 122 to a transfer position of a toner image; a sheet feeding roller 132 that takes over the sheet fed from the second sheet feeding cassette 1002b or from a lower sheet feeding cassette by a pickup roller 131, and feeds the sheet to the conveyance path; and a vertical conveyance roller 133 that takes over the sheet fed from the sheet feeding roller 132 and feeds the sheet to the timing roller 123.

The mechanical controller 105 illustrated in FIG. 2 issues a drive command to: a motor that is a drive source of each of the sheet feeding rollers 122 and 132, the timing roller 123, and the vertical conveyance roller 133; and a clutch that transmits drive force of the motor to each of the rollers. Also, the mechanical controller 105 detects arrival of a sheet by a sheet sensor (not illustrated) installed on the conveyance path.

Furthermore, the transmission element 115 and the reception element 116 constituting the ultrasonic sensor 117 illustrated in FIG. 2 are installed at an upstream position of the timing roller 123.

### [4] Internal Components of Signal Processor 107

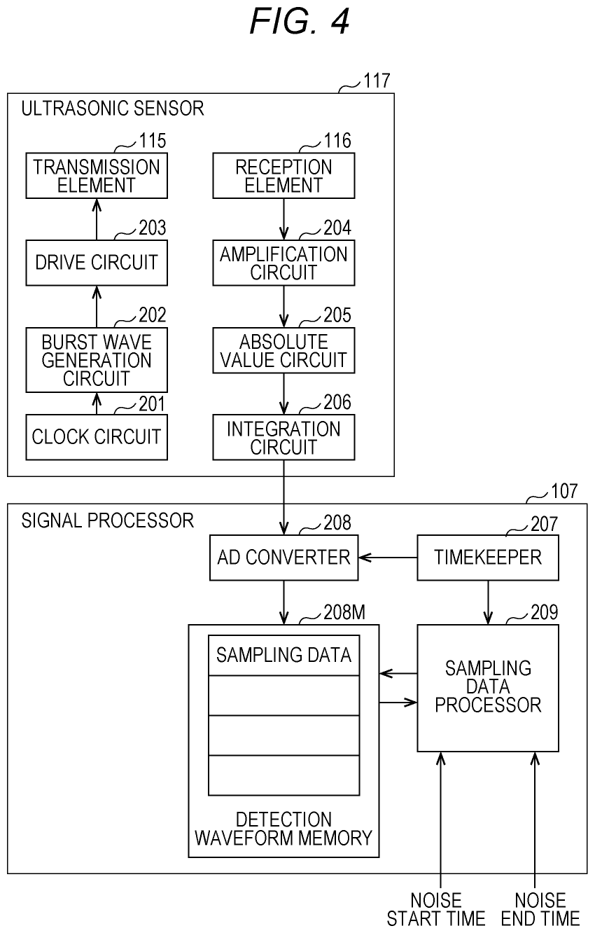

FIG. 4 is a block diagram illustrating internal components of the ultrasonic sensor 117 and the signal processor 107. As illustrated in this drawing, the ultrasonic sensor 117 includes a clock circuit 201, a burst wave generation circuit 202, a drive circuit 203, an amplification circuit 204, an absolute value circuit 205, and an integration circuit 206 in addition to the transmission element 115 and the reception element 116 illustrated in FIG. 2. Additionally, the signal processor 107 includes a timekeeper 207, an AD converter 208, and a sampling data processor 209.

(4-1) Clock Circuit 201

The clock circuit 201 generates a clock signal having a frequency unique to the transmission element.

(4-2) Burst Wave Generation Circuit 202

The burst wave generation circuit 202 converts a clock signal generated by the clock circuit 201 into a burst wave.

(4-3) Drive Circuit 203

The drive circuit 203 applies, to the transmission element 115, voltage according to a peak value of the burst wave generated by the burst wave generation circuit 202, and causes the transmission element 115 to transmit an ultrasonic wave. Thus, the ultrasonic wave transmitted from the transmission element 115 passes through a sheet that passes through the conveyance path, and the ultrasonic wave is received by the reception element 116. The reception element 116 having received the ultrasonic wave outputs an AC signal in response to the reception of the ultrasonic wave. Note that the transmission element 115 and the reception element 116 transmit and receive ultrasonic waves in a frequency band of 300 KHz.

(4-4) Amplification Circuit 204

The amplification circuit 204 amplifies the AC signal output from the reception element 116 to a voltage level that can be processed by a standard logic circuit.

(4-5) Absolute Value Circuit 205

The absolute value circuit 205 converts a detection signal output from the reception element 116 into an absolute value by leaving a positive half-wave portion of the AC signal amplified by the amplification circuit 204.

(4-6) Integration Circuit 206

The integration circuit 206 applies integration processing to the detection signal that has been converted into the absolute value by the absolute value circuit 205, and makes the detection signal in a form suitable for quantization by the AD converter 208.

(4-7) Timekeeper 207

The timekeeper 207 starts timekeeping after each job is started.

(4-8) AD Converter 208

The AD converter 208 quantizes a detection signal of the ultrasonic sensor 117 output from the reception element 116 at a predetermined sampling frequency, converts a waveform of the detection signal into discrete values (pieces of sampling data), and writes generated pieces of sampling data in a detection waveform memory 208M. Furthermore, the AD converter 208 generates a time stamp on the basis of a timekeeping value by the timekeeper 207, and assigns the time stamp to each piece of sampling data.

(4-9) Sampling Data Processor 209

The sampling data processor 209 refers to the time stamp assigned to each piece of sampling data stored in the detection waveform memory 208M and removes, from the detection signal, pieces of sampling data occupying the period from the noise start time to the noise end time notification of which is provided from the noise analyzer 106. Such noise removal is performed for every noise factor, and an attenuation degree of an ultrasonic wave at the time of a sheet passage through an installation place of the sensor is calculated by using remaining pieces of sampling data, and the double feed determination is executed on the basis of the attenuation degree.

### [5] Operation of Image Forming Apparatus

Operation of the image forming apparatus having the above-described configuration will be described.

When the image forming apparatus 1000 is installed in an office or the like and started to be used, the noise analyzer 106 accesses the management server 2001 via the public network, downloads the database 106D from the management server 2001, and writes the database 106D in a memory 106M in FIG. 2.

(5-1) Database 106D

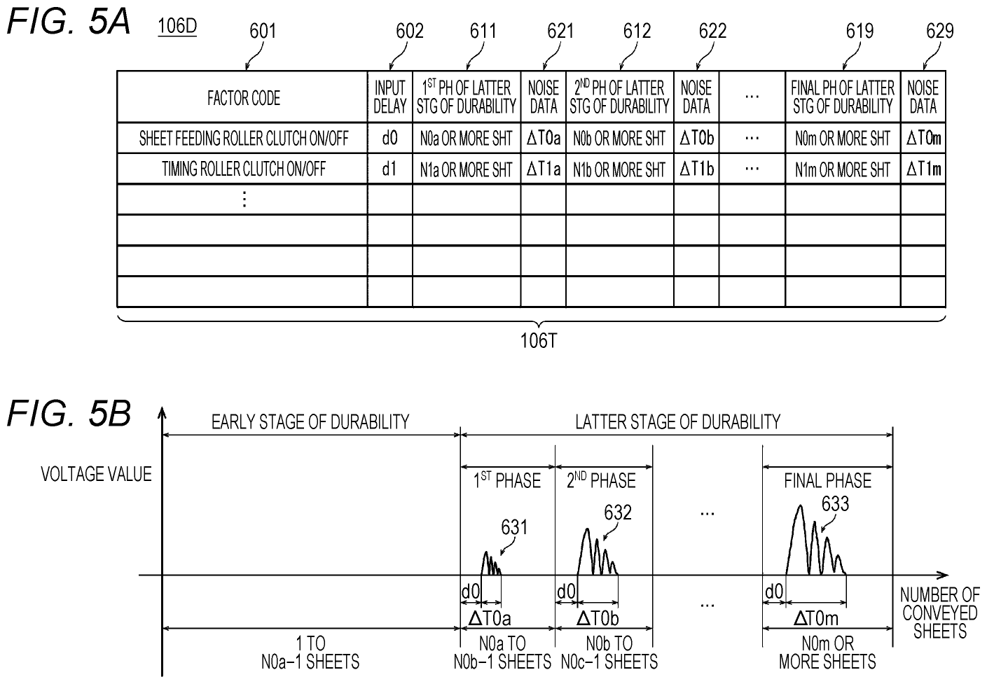

The database 106D is an increase tendency look-up table 106T illustrated in FIG. 5A and has a matrix structure in which factor codes indicating a plurality of noise factors that may occur during sheet conveyance are arrayed in a column direction, and an input delay 602 and respective phases 611, 612, . . . , and 619 of a latter stage of durability corresponding to the factor code 601 are arrayed in a row direction. The increase tendency look-up table 106T stores pieces of noise data 621, 622, . . . , and 629 in two-dimensional positions each of which is determined by a position in the row direction and a position in the column direction, and search by using a noise factor and the number of conveyed sheets can be performed therein. Each piece of noise data thus stored represents a noise predicted to be generated on the basis of a combination of a noise factor and the number of conveyed sheets which the count value of the conveyed sheet counter 105C may take, and each noise factor and the number of conveyed sheets designate a two-dimensional position of each piece of noise data. Furthermore, in the increase tendency look-up table 106T, one row in the matrix forms a record unit using a noise factor as an index, and addition, editing, or deletion is made on this increase tendency look-up table 106T per the record unit. The factor code 601 in FIG. 5A includes a code indicating clutch on/off control of the sheet feeding roller 122 and a code indicating clutch on/off control of the timing roller 123 by the mechanical controller 105. When notification of any clutch on/off drive control of the sheet feeding roller 122 is provided from the mechanical controller 105, or when notification of any clutch on/off drive control of the timing roller 123 is provided from the mechanical controller 105, the searcher 108 searches the increase tendency look-up table 106T by using, as keywords, the factor code 601 notification of which is provided and the number of conveyed sheets counted by the conveyed sheet counter 105C.

FIG. 5B illustrates a noise increase tendency in an early stage of durability and the latter stage of durability. In FIG. 5B, a horizontal axis represents a count value (the number of conveyed sheets) by the conveyed sheet counter 105C, and a vertical axis represents a noise peak value. On this horizontal axis, the number of sheets from one to N0a-1 sheets is defined as the early stage of durability, and the number of sheets from N0a or more sheets is defined as the latter stage of durability. Furthermore, the number of sheets from N0a to N0b-1 sheets is defined as a first phase of the latter stage of durability, the number of sheets from N0b to N0c-1 sheets is defined as a second phase of the latter stage of durability, and the number of sheets from N0m or more sheets is defined as a final phase of the latter stage of durability. In this case, in the increase tendency look-up table 106T, N0a sheets, N0b sheets, and N0m sheets are specified as threshold values of the first phase, the second phase, and the final phase of the latter stage of durability, respectively. Note that the N0a sheets, which is the threshold value in the first phase of the latter stage of durability, is preferably set to about 500,000 to 1,000,000 sheets, for example. The reason is that mechanical deterioration such as vibration increase may occur when the number of conveyed sheets reaches about 1,000,000 sheets.

Also, it is predicted that noises 631, 632, and 633 may appear in the first phase, the second phase, and the final phase of the latter stage of durability. Such prediction may be preliminarily stored on the basis of results of endurance test of the image forming apparatus 1000 of the same model, or may be updated as necessary with new prediction obtained on the management server 2001 side. In this case, in the increase tendency look-up table 106T, continuation periods ΔT0a, ΔT0b, and ΔT0m are specified for the respective pieces of noise data 621, 622, and 629 of the increase tendency look-up table 106T as periods during which the noises continue in the first phase, the second phase, and the final phase, respectively. Since the above-described details are specified in the increase tendency look-up table 106T, it is possible to determine which phase out of the first phase, the second phase, and the final phase of the latter stage of durability the number of conveyed sheets counted by the conveyed sheet counter 105C belongs to. Furthermore, it is possible to grasp a noise continuation period in a current deterioration phase.

After the above-described increase tendency look-up table 106T is written in the memory, use of the image forming apparatus 1000 is started. After the use of the image forming apparatus 1000 is started, every time a sheet is conveyed by the mechanical controller 105, the ultrasonic sensor 117 irradiates, with an ultrasonic wave, the sheet that passes through the installation place of the sensor.

(5-2) Double Feed Determination

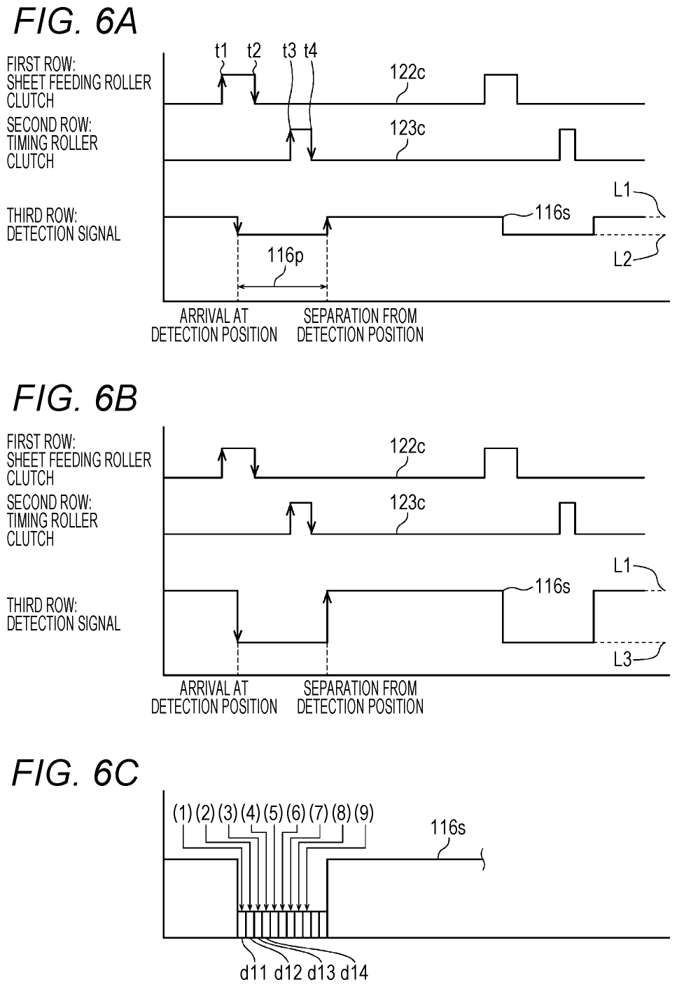

FIG. 6A and FIG. 6B are timing charts illustrating: drive commands of the mechanical controller 105 in the first phase of the latter stage of durability; and a detection signal from the ultrasonic sensor 117. As illustrated in signal waveforms 122c and 123c of a first row and a second row of FIG. 6A, the mechanical controller 105 turns on the clutch of the sheet feeding roller 122 at a timepoint t1 after a sheet is fed from a sheet feeding cassette, and the sheet is nipped at the nip and fed toward the timing roller 123. After that, when a leading edge of the sheet arrives at the nip of the timing roller 123, the clutch of the sheet feeding roller 122 is turned off at a timepoint t2. Then, the timing roller 123 is turned on at a timepoint t3 to feed the sheet to the transfer device 112 by the timing roller 123, and the clutch of the timing roller 123 is turned off at a timepoint t4. After that, the sheet is conveyed toward the transfer device 112 and the fixing device 113. At this time, the timing roller 123 is rotationally driven with the sheet conveyance.

A description will be provided how a detection signal output from the ultrasonic sensor 117 is changed in these processes. In a case where a single sheet without overlapping passes through, a detection signal at the time of sheet passage is slightly attenuated as illustrated in a third row of FIG. 6A, and a signal level of the ultrasonic sensor 117 is decreased from a non-detection level L1 to a single sheet attenuation level L2. However, in a case where overlapping sheets pass through, a detection signal at the time of sheet passage is largely attenuated as illustrated in a third row of FIG. 6B, and the signal level of the ultrasonic sensor 117 is decreased from the non-detection level L1 to a double feed attenuation level L3.

When a detection signal is thus obtained during the sheet passage, the AD converter 208 performs sampling from the detection signal at the predetermined sampling frequency and obtains pieces of discrete sampling data d11, d12, d13, d14, and the like as illustrated in FIG. 6C.

In the double feed determination, whether or not the sheets are fed in an overlapping manner from the sheet feeding cassette 1002a is determined by using the pieces of sampling data obtained in the above-described processes.

To execute such determination accurately, it is necessary to: have a reasonable margin between the signal level (single sheet attenuation level L2 in FIG. 6A) of the detection signal at the time of passage of the sheet without overlapping and the signal level (double feed attenuation level L3 in FIG. 6B) at the time of passage of the overlapping sheets; and clearly discriminate these signal levels from each other.

(5-3) Noises Superimposed on Detection Signal of Ultrasonic Sensor 117

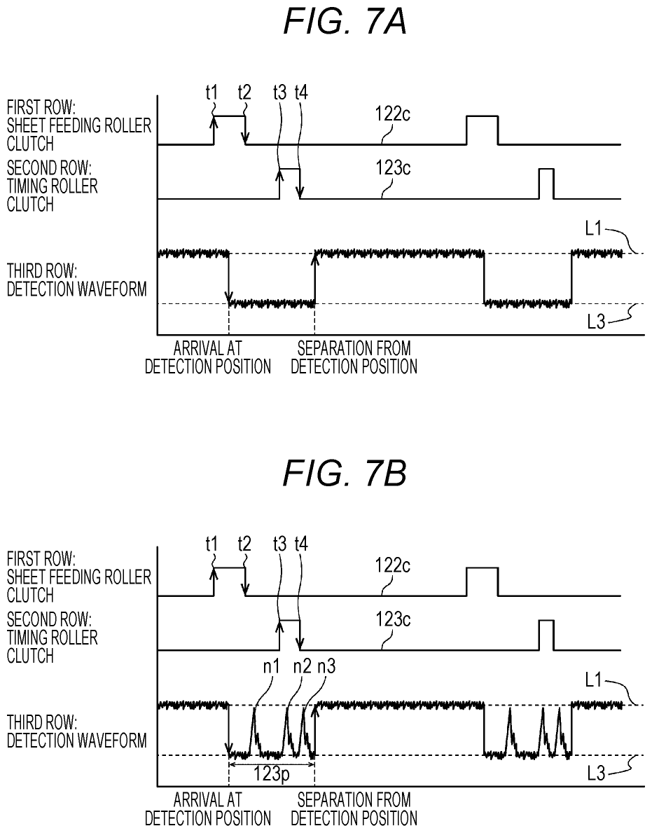

A description will be provided for kinds of noise signals superimposed on the detection signal of FIG. 6B due to vibration of the transmission element 115 and the reception element 116. FIG. 7A illustrates the detection signal on which noises are superimposed in the early stage of durability.

In a case where age of use is still short and the noises stay at a low level, a sufficient margin can be ensured between the non-detection level L1 and the double feed attenuation level L3 even though signals caused by the noises are superimposed on the detection signal.

FIG. 7B illustrates the detection signal on which noises are superimposed in the latter stage of durability. In the latter stage of durability, the noises superimposed on the detection signal of the reception element 116 have a high level. Among these noises, noises that particularly intensively appear on the detection signal are: a noise n1 that appears due to rotation of the sheet feeding roller 122; and noises n2 and n3 that appear due to rotation of the timing roller 123. In the latter stage of durability, the superimposed noises have the high level, and the double feed attenuation level L3 at the time of passage of the overlapping sheets gradually becomes close to the non-detection level L1. As a result, a boundary between both signal levels becomes ambiguous, thereby causing erroneous determination.

Even when the mechanical controller 105 issues a drive command, such a noise is not generated immediately after the drive command. The clutch is engaged in response to the drive command, and rotation of each of the sheet feeding roller 122 and the timing roller 123 which are rotation loads is started, thereby causing vibration. Specifically, a gear of a drive motor has backlash, and the rotation of the rotation loads is started after the drive motor is rotated for a while. The vibration is generated at the time when the rotation of the rotation loads is started. In a case where a frame where the ultrasonic sensor 117 is installed loses robustness, a noise caused by the vibration is superimposed on the detection signal of the ultrasonic sensor 117. Thus, the time when vibration of a drive system is generated can be predicted to a certain extent from: timing of commanding engagement (clutch on) between a drive-side rotor and a load-side armature of the clutch; and timing of commanding disengagement (clutch off) between the drive-side rotor and the load-side armature of the clutch. The input delay 602 in the increase tendency look-up table 106T clarifies a delay time that is a period from when the clutch on/off is commanded until noise superposition is started.

(5-4) Apparatus Noise Prevention Processing

The noise analyzer 106 and the signal processor 107 execute apparatus noise prevention processing.

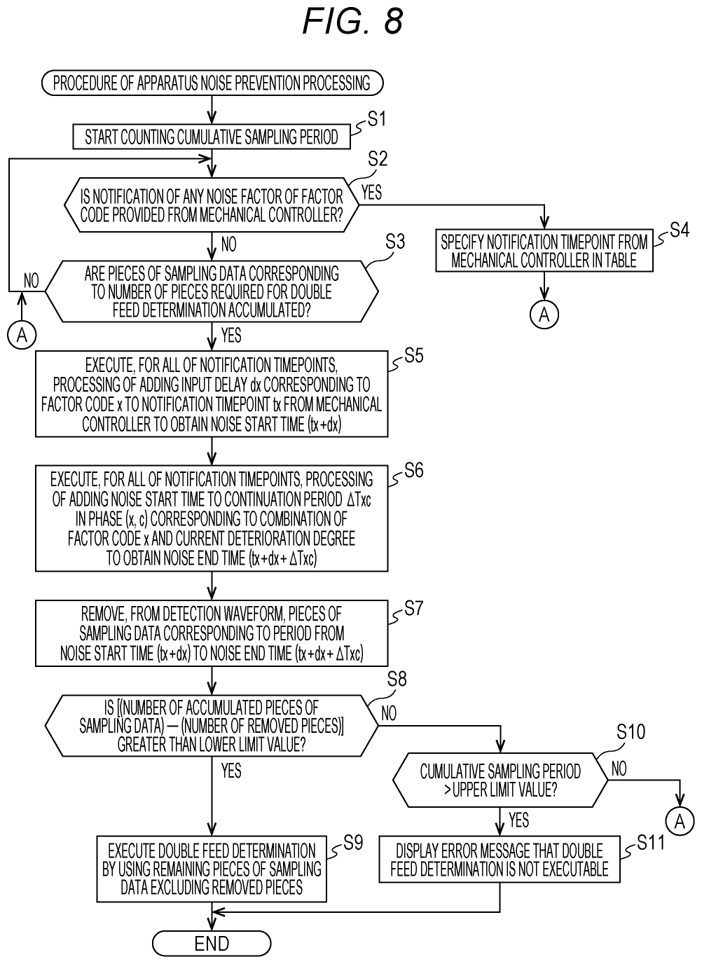

The apparatus noise prevention processing executed by the signal processor 107 will be described with reference to the flowchart in FIG. 8.

First, counting for a cumulative sampling period is started (step S1), and the processing shifts to a loop of steps S2 and S3. In step S2, whether or not notification of a noise factor of any factor code specified in the increase tendency look-up table 106T is provided from the mechanical controller 105 is determined, and in step S3, whether or not pieces of sampling data corresponding to the number of pieces required for the double feed determination are accumulated is determined. In a case where notification of the noise factor of any factor code is provided from the mechanical controller 105 (Yes in step S2), a notification timepoint from the mechanical controller 105 is specified in a noise analysis table 106A (step S4). With repetition of such specifying operation, notification timepoints of the noise factors corresponding to the plurality of factor codes specified in the increase tendency look-up table 106T are specified in the noise analysis table 106A. Among the plurality of noise factors, an arbitrary noise factor is specified by using a variable x. Additionally, a notification timepoint corresponding to the arbitrary noise factor x is defined as tx, and an input delay is defined as dx. Furthermore, the current number of conveyed sheets updated by the conveyed sheet counter 105C is defined as a current deterioration degree c. Then, among the continuation periods in the respective phases specified in the increase tendency look-up table 106T, a continuation period corresponding to the current deterioration degree c and the arbitrary noise factor x will be referred to as ΔTxc.

In a case where pieces of sampling data corresponding to the number of pieces required for the double feed determination are accumulated, noise start time (tx+dx) is calculated by: adding the input delay dx of the corresponding factor code x to the notification timepoint tx from the mechanical controller 105; and mapping this result on a time axis of the detection signal (step S5). Such calculation of the noise start time (tx+dx) is executed for all of notification timepoints specified in the noise analysis table 106A. Subsequently, noise end time (tx+dx+ΔTxc) is obtained by: adding, to the noise start time, the continuation period ΔTxc in a phase (x, c) corresponding to the combination of the factor code x and the current deterioration degree c; and mapping the result on the time axis of the detection signal (step S6). Such calculation of the noise end time (tx+dx+ΔTxc) is executed for all of the notification timepoints specified in the noise analysis table 106A.

Then, pieces of sampling data corresponding to a period from the noise start time (tx+dx) to the noise end time (tx+dx+ΔTxc) are removed (step S7). Next, it is determined whether or not a value obtained by subtracting the number of removed pieces from the number of accumulated pieces of the sampling data is greater than a lower limit value required for the double feed determination (step S8). In a case where the value is greater, the double feed determination is executed by using the remaining pieces of sampling data excluding the removed pieces of sampling data (step S9), and the processing of this flowchart ends.

In a case where the value obtained by subtracting the number of the removed pieces is smaller than the lower limit value required for the double feed determination, whether or not the cumulative sampling period at the time of starting the counting in step S1 is greater than an upper limit value is determined (step S10). In a case where the cumulative sampling period is not greater (No in step S10), the processing returns to the loop of steps S2 to S3. In a case where the cumulative sampling period is greater (Yes in step S10), an error screen indicating that the double feed determination is not executable is displayed on the touch panel display 1001 (step S11), and the processing of this flowchart ends.

(5-5) Processes in Processing for Sampling Data

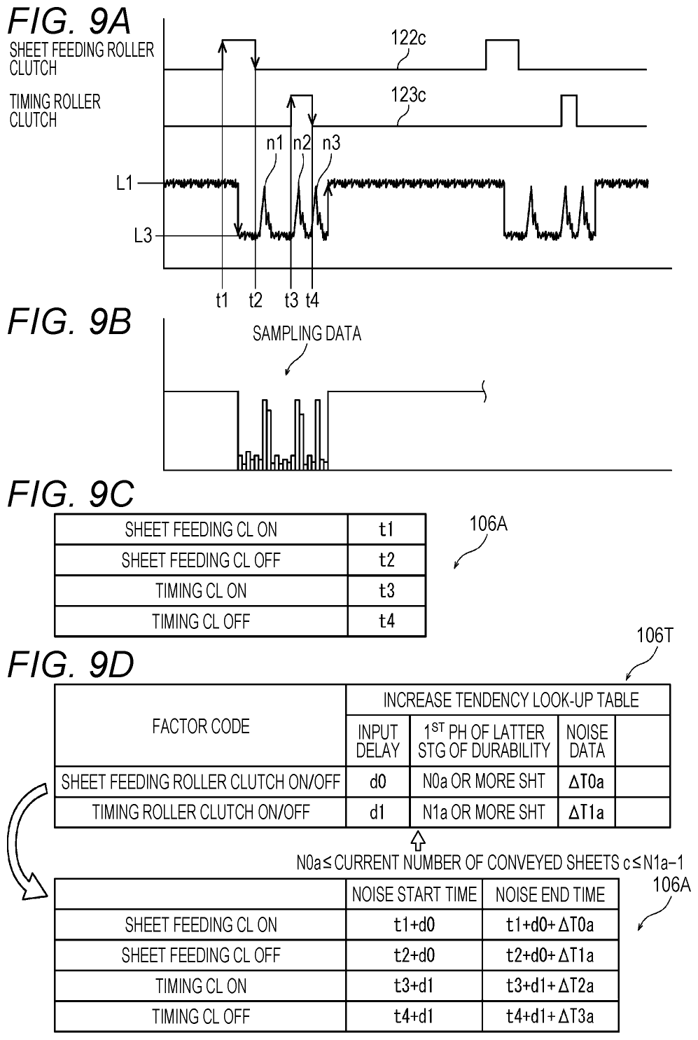

FIG. 9A to FIG. 9D illustrate processes in processing performed by the AD converter 208 and the sampling data processor 209. As illustrated in FIG. 9A, in a case where a detection signal on which noises n1, n2, and n3 are superimposed is received, the AD converter 208 quantizes voltage values that are peak values of the detection signal having these noises superimposed. Consequently, a plurality of pieces of discrete sampling data as illustrated in FIG. 9B is written in the memory.

During such sampling period, notification of timepoints t1 and t2 at which the clutch (sheet feeding clutch) of the sheet feeding roller 122 is turned on/off and timepoints t3 and t4 at which the clutch (timing clutch) of the timing roller 123 is turned on/off is provided from the mechanical controller 105. At this time, the sampling data processor 209 specifies these clutch on/off timepoints t1, t2, t3, and t4 in the noise analysis table 106A, as illustrated in FIG. 9C.

The searcher 108 searches the increase tendency look-up table 106T of the database 106D by using the current number of conveyed sheets counted by the conveyed sheet counter 105C and the factor codes notification of which is provided from the mechanical controller 105, and reads out, from the increase tendency look-up table 106T: input delays d0 and d1 in clutch on/off corresponding to the respective factor codes; and noise continuity periods ΔT0a and ΔT1a corresponding to the respective factor codes.

Then, the noise start time and the noise end time are defined by adding the input delays and the noise continuity periods to the clutch on/off timepoints t1, t2, t3, and t4 respectively, and mapping the results on the time axis of the detection signal. Then, the noise start time and the noise end time are specified in the noise analysis table 106A, the noise start time and the noise end time of each of the factors indicated in the factor codes are clarified. FIG. 9D illustrates an example of the noise analysis table 106A in which the noise start time and the noise end time are specified. As illustrated in the drawing, in the noise analysis table, the noise start time of the noise factor of the clutch on of the sheet feeding roller 122 is specified as (t1+d0), and the noise end time thereof is specified as (t1+d0+ΔT0a). Additionally, the noise start time of the noise factor of the clutch off of the sheet feeding roller 122 is specified as (t2+d0), and the noise end time thereof is specified as (t2+d0+ΔT1a). The noise start time and the noise end time of the timing roller 123 can also be grasped by performing a similar procedure.

Thus, since the noise start time and the noise end time are identified, pieces of sampling data to be removed from among the pieces of sampling data illustrated in FIG. 9B are identified.

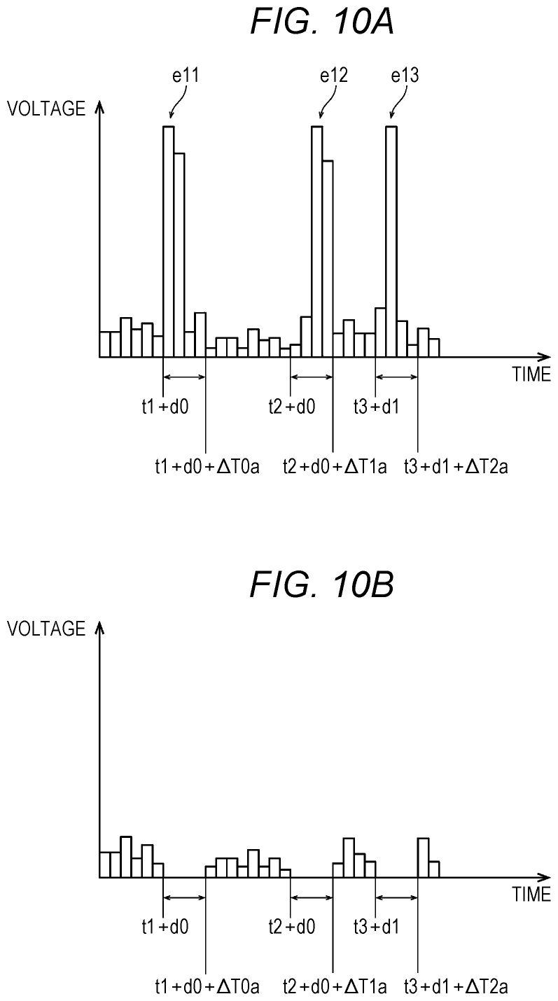

Each piece of sampling data has a time width corresponding to the sampling frequency, and therefore, a piece of the sampling data corresponding to the noise start time and a piece of the sampling data corresponding to the noise end time are identified by converting the noise start time and the noise end time into time accuracy of the sampling frequency. Thus, assume that pieces of the sampling data e11, e12, and e13 illustrated in FIG. 10A are identified as the pieces of sampling data to be removed (step S6 in FIG. 8). In this case, these pieces of sampling data e11, e12, and e13 are removed (step S7 in FIG. 8), a sampling data array illustrated in FIG. 10B is obtained, and peak values of such pieces of sampling data are set as targets of the double feed determination.

(5-6) Error Display

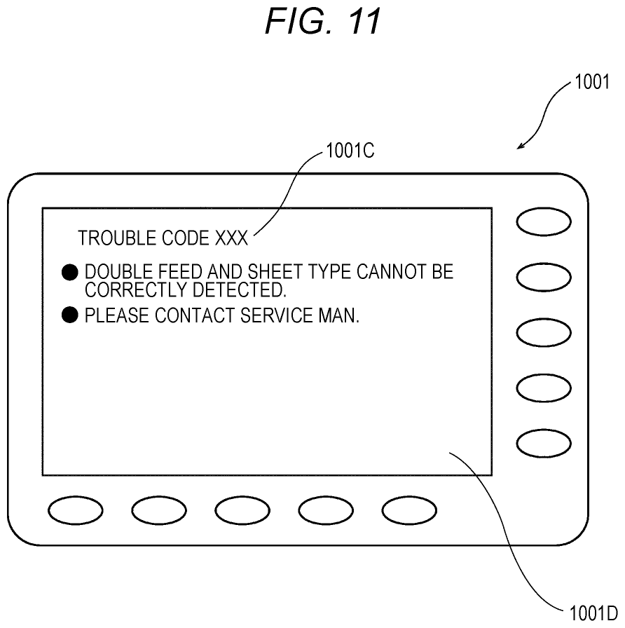

In the double feed determination, the number of pieces of sampling data in the detection waveform may not reach the number of pieces of sampling data required for the double feed determination as a result of removing some pieces of sampling data from the detection waveform of the detection signal. In a case where the number of pieces of sampling data in the detection waveform does not reach the lower limit value of the number of sampling data required for the double feed determination and the cumulative sampling period is determined to be greater than an allowable period (the upper limit value) (Yes in step S10 in FIG. 8), the pieces of sampling data required for the double feed determination cannot be obtained. In this case, sampling from the detection signal by the ultrasonic sensor 117 is stopped, a notification of a trouble code is sent to the system controller 101 of the image forming apparatus 1000, and an error is displayed on the touch panel display 1001 (step S11). FIG. 11 illustrates an exemplary error screen displayed in step S11. An error screen 1001D in FIG. 11 displays a message indicating that the sheet double feed cannot be correctly determined, and displays a trouble code 1001C indicating the fact for a user or a service man.

### [6] Conclusion

As described above, according to the present embodiment, temporal increase of noises caused by continuous use of the conveyor 1100 is clearly indicated in the increase tendency look-up table 106T in a manner correlated to each of the phases in the latter stage of durability. Therefore, the noise analyzer 106 can grasp the temporal increase of the noises in accordance with deterioration of the conveyor 1100 by searching the increase tendency look-up table 106T by using the current number of conveyed sheets. Since some pieces of sampling data are removed on the basis of the temporal increase of the noises thus grasped, the number of removed pieces of the sampling data can be minimized. Furthermore, even when the conveyor 1100 is used for a long term, it is possible to maintain determination accuracy of the double feed determination.

### Second Embodiment

### [7] Outline of Second Embodiment

Control using an increase tendency look-up table 106T by a noise analyzer 106 described in an above-described embodiment is control that does not utilize feedback from an image forming apparatus 1000 and is performed by using only a control system assumed in the increase tendency look-up table 106T. In the control theory, such control is classified as open-loop control. However, such open-loop control has a problem of having a deviation between an actual operating state of the image forming apparatus 1000 and content of the increase tendency look-up table 106T.

Accordingly, a self-evaluator 109 of a conveyor 1100 illustrated in FIG. 2 adjusts, in accordance with deterioration caused by use of the conveyor 1100, the increase tendency look-up table 106T that has been downloaded from a management server 2001. For such adjustment, the increase tendency look-up table 106T according to a second embodiment includes reference waveform data 106S.

### [8] Reference Waveform Data 106S

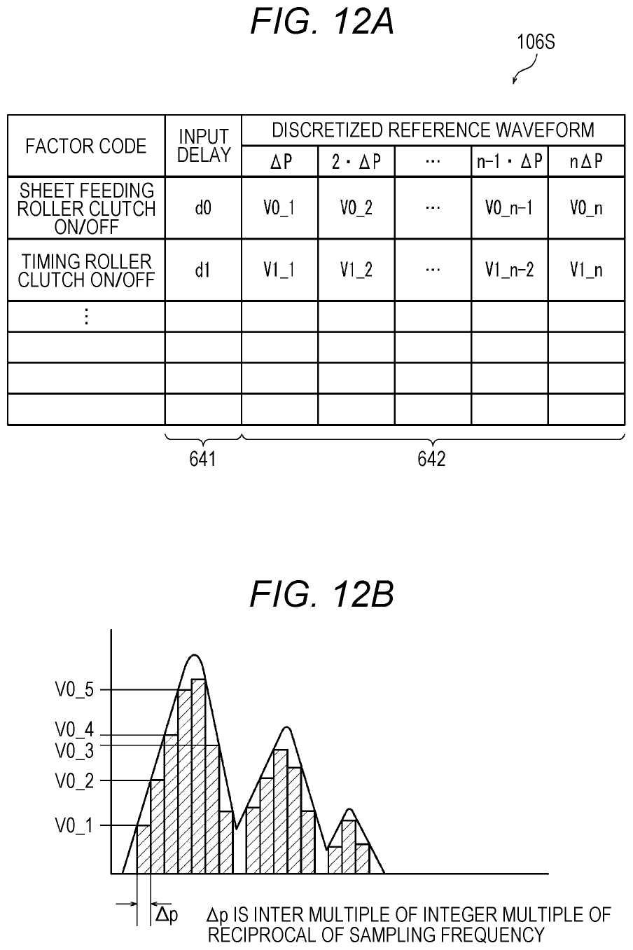

The reference waveform data 106S is data reproducing a signal waveforms in a state where an appropriate noise amount is superimposed in accordance with a degree of aged deterioration indicated by the number of conveyed sheets counted by a conveyed sheet counter 105C, and the reference waveform data 106S is used as a reference of the aged deterioration (referred to as a reference waveform). FIG. 12A illustrates exemplary reference waveform data 106S. As illustrated in this drawing, the reference waveform data 106S is formed by correlating, to an input delay 641 and a sampling data array 642, each of factor codes similar to those in the increase tendency look-up table 106T. V0_1, V0_2 to V0_N in the sampling data array 642 represent a plurality of voltage values obtained by discretizing a noise waveform per sampling cycle ΔP in a waveform shape of FIG. 12B.

### [9] Processing Details of Self-evaluator 109

The reference waveform data 106S is provided for each of a plurality of phases illustrated in the increase tendency look-up table 106T, and reproduces a detection waveform output from an ultrasonic sensor 117. The self-evaluator 109 illustrated in FIG. 2 evaluates whether or not a noise superimposed on the detection signal output from the ultrasonic sensor 117 is appropriate according to a degree of the aged deterioration indicated by the number of conveyed sheets of the conveyed sheet counter 105C.

When a count value of the conveyed sheet counter 105C reaches a phase corresponding to the reference waveform data 106S, comparison is performed between the detection waveform of the ultrasonic sensor 117 and the reference waveform in the reference waveform data 106S corresponding to this phase.

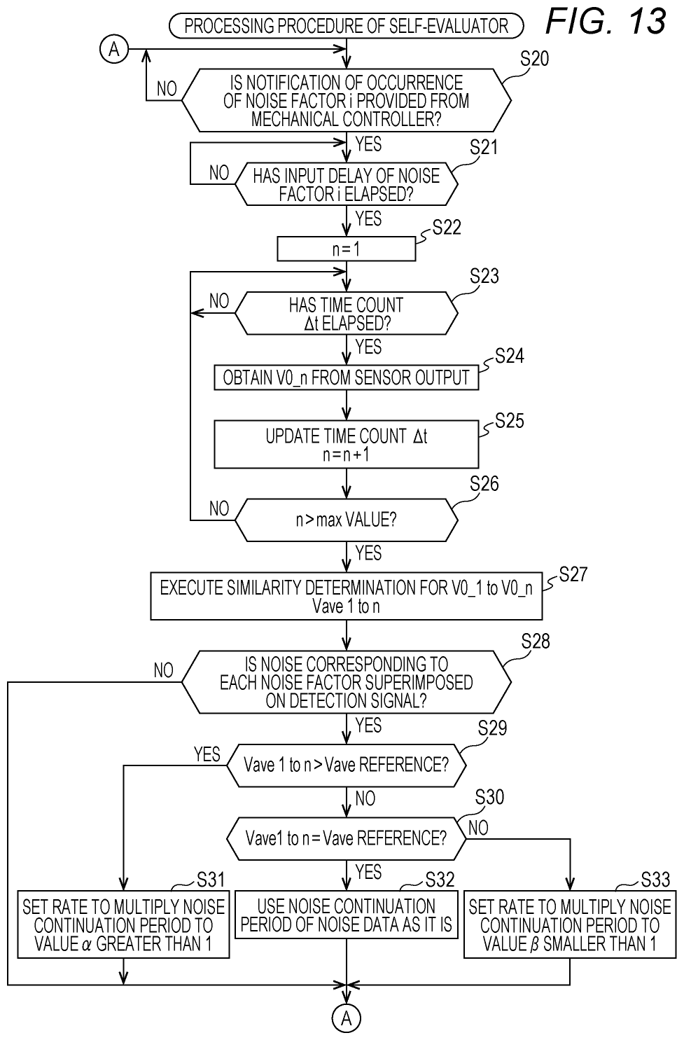

FIG. 13 is a flowchart illustrating a processing procedure of the self-evaluator 109. In step S20 of the flowchart of FIG. 13, whether or not notification of occurrence of a noise factor i corresponding to the reference waveform data 106S is provided from a mechanical controller 105 is determined, and the self-evaluator 109 repeats a loop of step S20 until such notification is provided (No in step S20). When notification of occurrence of the noise factor i is provided (Yes in step S20), the processing starts waiting until an input delay corresponding to the noise factor i has elapsed (No in step S21), and when the input delay has elapsed, the processing shifts to a loop including steps S22 to S26. A variable n is a control variable of this loop and indicates each piece of sampling data. A requirement to continue this flowchart is that the variable n is a maximum value (max value) or less (No in step S26). As far as this continuation requirement is satisfied, an AD converter 208 receives the detection signal of the ultrasonic sensor 117, outputs an n-th piece of sampling data V0_n (step S24), and updates time count Δt and the variable n (step S25).

Thus, in a case where maximum pieces of sampling data V0_1, V0_2, V0_3 to V0_max are obtained, similarity between the reference waveform represented by the reference waveform data 106S and the signal waveform of the detection signal is determined (step S27). Various methods can be applied as a method of determining the similarity. Examples of such a method includes calculation of a vector indicating a waveform shape, integration of a difference between respective peak values of both waveforms, and the like. In the present embodiment, an average of peak values of respective pieces of sampling data in the detection signal of the ultrasonic sensor 117 (hereinafter, referred to as voltage average value Vave 1 to n), and an average of peak values of respective pieces of sampling data in the reference waveform data 106S (hereinafter, referred to as voltage average value Vave reference) are calculated, and similarity between both waveforms is determined by comparing these voltage average values.

In a case where the detection waveform of the ultrasonic sensor 117 is similar to the reference waveform of the reference waveform data 106S, whether or not a noise caused by each noise factor specified in the increase tendency look-up table 106T is superimposed on the detection signal of the ultrasonic sensor 117 is determined (step S28). In a case where a noise caused by a noise factor specified in the increase tendency look-up table 106T is not superimposed on the detection signal of the ultrasonic sensor 117 (No in step S28), the processing of this flowchart ends.

In a case where a noise caused by a noise factor specified in the increase tendency look-up table 106T is superimposed on the detection signal of the ultrasonic sensor 117 (Yes in step S28), determination is made on whether or not the voltage average value Vave 1 to n of the detection signal of the ultrasonic sensor 117 is greater than the voltage average value Vave reference of the reference waveform data 106S (step S29). In a case where the voltage average value Vave 1 to n of the detection signal of the ultrasonic sensor 117 is greater than the voltage average value Vave reference of the reference waveform data 106S (Yes in step S29), a rate to multiply a noise continuation period of noise data is set to a value α greater than 1 (step S31). This value α is a weighting factor to multiply the noise continuation period of the noise data. In a case where step S29 results in No, determination is made on whether or not the voltage average value Vave 1 to n of the detection signal of the ultrasonic sensor 117 is equal to the voltage average value Vave reference of the reference waveform data 106S (step S30). In a case where the voltage average value Vave 1 to n of the detection signal of the ultrasonic sensor 117 is equal to the voltage average value Vave reference of the reference waveform data 106S (Yes in step S30), the noise continuation period of the noise data is used as it is for noise removal (step S32). In a case where the voltage average value Vave 1 to n of the detection signal of the ultrasonic sensor 117 is smaller than the voltage average value Vave reference of the reference waveform data 106S (No in step S30), the rate to multiply the noise continuation period of the noise data is set to a value β smaller than 1 (step S33). This value β is also a weighting factor to multiply the noise continuation period of the noise data. In a case where the average value of peak values is high, the weighting factor α is a preset value under the assumption that a long period is required for a noise level to be decreased to such an extent that the noise does not affect the detection signal. In a case where the average value of peak values is low, the weighting factor 13 is a preset value under the assumption that a short period is required for the noise level to be decreased to such an extent that the noise does not affect the detection signal. The values of the weighting factors α and β are determined on the basis of a result of a preliminary endurance test.

### [10] Specific Details of Adjustment by Self-Evaluator 109

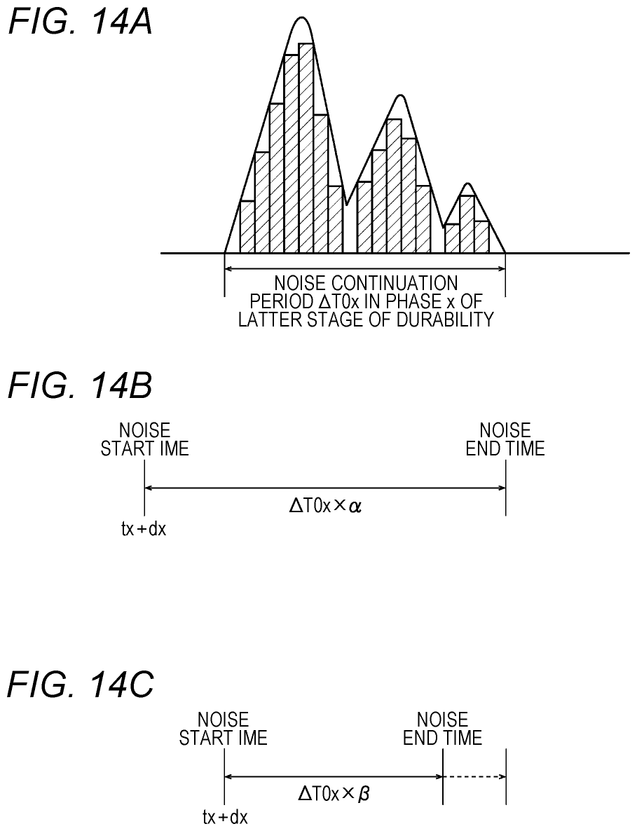

Here, assume that the detection signal output from the ultrasonic sensor 117 forms a waveform shape of FIG. 14A and occupies a period ΔT0x on a time axis in a phase x of a latter stage of durability. Comparison between the voltage average value Vave 1 to n of the signal waveform of the detection signal in FIG. 14A and the voltage average value Vave reference of the reference waveform data 106S is performed in steps S29 and S30 of FIG. 13.

When the voltage average value Vave 1 to n of the signal waveform of the detection signal is greater than the voltage average value Vave reference of the reference waveform data 106S, step S29 results in Yes, and the rate to multiply the noise continuation period in each of the phases of the increase tendency look-up table 106T is set to the value α greater than 1 (step S31). In this case, assuming that pieces of sampling data corresponding to the noises occupy a period (ΔT0x×α) as illustrated in FIG. 14B, the noise analyzer 106 defines noise start time and noise end time on the basis of the period (ΔT0x×α). Specifically, the noise start time is defined as (tx+dx) obtained by adding an input delay dx of a factor code x to a notification timepoint tx from the mechanical controller 105, and the noise end time is defined as (tx+dx+ΔT0x×α) obtained by adding (ΔT0x×α) to the noise start time (tx+dx).

When the voltage average value Vave 1 to n of the signal waveform of the detection signal is smaller than the voltage average value Vave reference of the reference waveform data 106S, step S29 results in No and S30 results in No. Therefore, a rate to multiply the noise continuation period in each of the phases of the increase tendency look-up table 106T is set to the value β smaller than 1 (step S33). In this case, assuming that pieces of the sampling data corresponding to the noises occupy a period (ΔT0x×β) as illustrated in FIG. 14C, the noise analyzer 106 defines noise start time and noise end time on the basis of the period (ΔT0x×β). Specifically, the noise start time is defined as (tx+dx) obtained by adding the input delay dx of the factor code x to the notification timepoint tx from the mechanical controller 105, and the noise end time is defined as (tx+dx+ΔT0x×β) obtained by adding (ΔT0x×β) to the noise start time (tx+dx).

### [11] Conclusion

As described above, according to the present embodiment, the average voltage value of the detection waveform output from the ultrasonic sensor 117 is compared with the average voltage value of the reference waveform represented by the reference waveform data 106S, and adjustment is additionally made to the noise continuation period of the noise data in the increase tendency look-up table 106T on the basis of the comparison result. Therefore, the number of pieces of sampling data to be removed from the detection signal of the ultrasonic sensor 117 can be corrected to the optimal number in accordance with the deterioration degree caused by actual use of the conveyor 1100.

### [12] Modified Examples

The embodiments of the present invention have been described above, but needless to mention, the present invention is not limited to the above-described embodiments and following modified examples are conceivable.

(1) In the second embodiment, the noise continuation period of the noise data in the increase tendency look-up table 106T is adjusted, but not limited thereto. The time to start removal of sampling data in accordance with the noise data may be set earlier or later than the time when the number of conveyed sheets reaches the number of conveyed sheets specified in the increase tendency look-up table 106T.

Specifically, in the present modified example, each of threshold values (N0a, N0b, . . . , N0m in FIG. 5A) in the respective phases specified in the increase tendency look-up table 106T is multiplied by a weighting factor D, and each of the weighted number of conveyed sheets (N0a·D, N0b·D, . . . , N0m·D) is defined as a reference of deterioration caused by the use of the conveyor 1100. Then, sampling data removal using the noise data is executed depending on whether or not the number of conveyed sheets counted by the conveyed sheet counter 105C is greater than this reference of deterioration.

The above-described weighting factor D is determined in accordance with the determination results in steps S29 and S30 of the flowchart of FIG. 13. That is, in the case where the voltage average value Vave 1 to n of the signal waveform of detection signals is greater than the voltage average value Vave reference of the reference waveform in the reference waveform data 106S (Yes in step S29), the weighting factor D of the number of conveyed sheets is set to a predetermined value smaller than 1. Since the weighting factor D is set to the value smaller than 1, the threshold values N0a·D to N0m·D after the adjustment in the increase tendency look-up table 106T also become smaller than the threshold values N0a to N0m. Since the threshold value in each of the phases of the increase tendency look-up table 106T is corrected to the lower number, sampling data removal using the noise data of the increase tendency look-up table 106T is started at the time earlier than time originally intended.

In the case where the voltage average value Vave 1 to n of the signal waveform of the detection signal is equal to the voltage average value Vave reference of the reference waveform in the reference waveform data 106S (No in step S29, and Yes in step S30), the weighting factor D of the number of conveyed sheets is set to 1.

In the case where the voltage average value Vave 1 to n of the signal waveform of the detection signal is smaller than the voltage average value Vave reference of the reference waveform in the reference waveform data 106S (No in step S29, and No in step S30), the weighting factor D of the number of conveyed sheets is set to the rate greater than 1. Since the weighting factor D of the number of conveyed sheets is set to the value greater than 1, the threshold values N0a·D to N0m·D after the adjustment in the increase tendency look-up table 106T are greater than the original threshold values N0a to N0m. Since the threshold value in each of the phases of the increase tendency look-up table 106T is corrected to a high value, the sampling data removal using the noise data of the increase tendency look-up table 106T is started at the time later than the time originally intended.

Since the above-described weighting factor D is adjusted before the number of conveyed sheets counted by the conveyed sheet counter 105C reaches each of the threshold values N0a to N0m, the time to execute partial removal of the detection signal is changed to appropriate time in accordance with the deterioration of the own apparatus.

(2) In the second embodiment, the self-evaluator 109 uses the reference waveform data 106S to adjust the increase tendency look-up table 106T in accordance with an actual use state of the conveyor 1100. On the other hand, in the present modified example, the self-evaluator 109 executes operation (factor-identifying operation) to identify: a kind of a noise generated in the image forming apparatus 1000; a kind of noise factor to which a factor of the noise corresponds to in the increase tendency look-up table 106T; and whether or not the noise is caused by an unexpected noise factor.

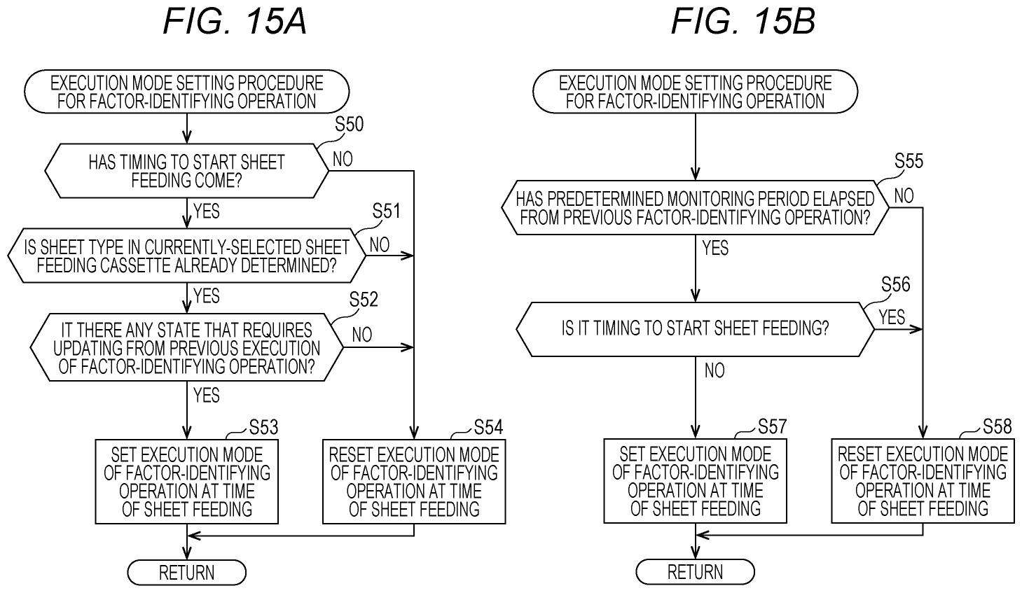

To execute the factor-identifying operation, the system controller 101 of the image forming apparatus 1000 sets, in accordance with the flowcharts of FIG. 15A and FIG. 15B, necessity/unnecessity of executing an execution mode of the factor-identifying operation.

FIG. 15A and FIG. 15B are flowcharts each illustrating a processing procedure in which the system controller 101 sets the execution mode to set whether or not to execute the factor-identifying operation for each vibration noise source.

In a case where the mechanical controller 105 determines whether or not timing to start sheet feeding has come while controlling the pickup roller 121 and the sheet feeding roller 122 (step S50), and in a case where the timing has come, the system controller 101 determines whether or not a sheet type in the currently-selected sheet feeding cassette 1002a is already determined (step S51). Then, whether or not there comes any state that requires updating from previous execution of the factor-identifying operation is determined (step S52). The “state that requires updating” represents a fact that a state change, such as sheet replacement in one of the sheet feeding cassettes 1002a, 1002b, 1002c, and 1002d, has taken place in the image forming apparatus 1000.

Generally, a plurality of sheets of the same type is stored in each of the sheet feeding cassettes 1002a, 1002b, 1002c, and 1002d. For example, in a case where the sheet type is a plain sheet, the plain sheets are stored in a cassette, and in a case where the sheet type is an envelope, the envelopes are stored in a cassette. As far as there is no state change, such as pulling out a sheet feeding cassette from the image forming apparatus 1000 and replacing sheets therein, it is not necessary to newly detect the sheet type. To execute the factor-identifying operation for a vibration noise in an occasion of sheet replacement, presence of the state that requires updating is determined. When both of steps S51 and S52 result in Yes, the execution mode is set to execute the factor-identifying operation in step S53. In other cases, the mode setting is reset (step S54), and normal operation is performed.

FIG. 15B is the flowchart illustrating processing of determining whether or not to forcibly execute the factor-identifying operation when the factor-identifying operation has not been executed for a predetermined period.

First, whether or not a predetermined monitoring period has elapsed from the previous factor-identifying operation is determined (step S55). The predetermined monitoring period is an execution cycle of the factor-identifying operation, and whether or not this predetermined period has elapsed is determined in step S55 with intention to forcibly execute the factor-identifying operation when this predetermined monitoring period has elapsed (step S55).

When the predetermined monitoring period has elapsed (Yes in step S55), determination is made on whether or not it is timing to start sheet feeding under the control of the mechanical controller 105 (step S56). In a case where it is not the timing to start the sheet feeding (No in step S56), the execution mode of the factor-identifying operation is set in step S57. In a case where it is the timing to start the sheet feeding (Yes in step S56), the execution mode of the factor-identifying operation is reset (step S58).

When the execution mode is set through the above-described processes, the self-evaluator 109 performs self-diagnosis on the conveyor 1100. As the self-diagnosis, both of cases where the transmission element 115 transmits ultrasonic waves and the transmission element 115 does not transmit ultrasonic waves are assumed. Some of the conveyance members located in the vicinity of the ultrasonic sensor 117 can be a source of ultrasonic waves. To identify such a source of the ultrasonic waves, the reception element 116 is made to output a detection signal without having the transmission element 115 transmit the ultrasonic waves, and it is necessary to evaluate whether or not any noise is in the detection signal. Since such diagnosis is required, every time the factor-identifying operation is executed, the system controller 101 cyclically switches necessity/unnecessity of transmission from the transmission element 115.

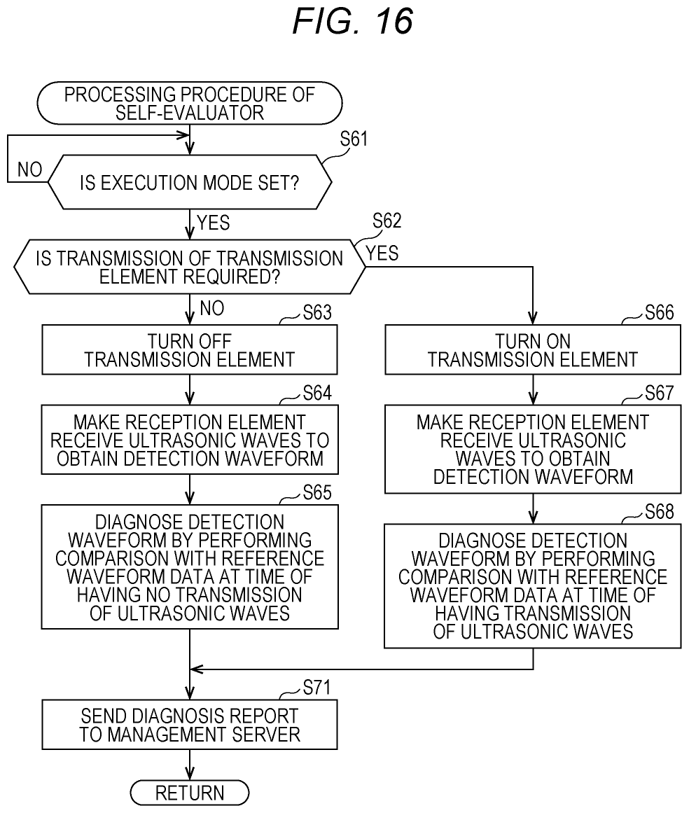

FIG. 16 is a flowchart illustrating a processing procedure of the self-evaluator 109 in accordance with the setting of the execution mode. The self-evaluator 109 waits until determination is made on whether or not the execution mode is set (step S61).

When the execution mode is set by the processing in the flowcharts of FIG. 15A and FIG. 15B (Yes in step S61), determination is made on whether the transmission element 115 has executed transmission in the previous factor-identifying operation and transmission of the transmission element 115 is not required this time or the transmission element 115 has not executed transmission in the previous factor-identifying operation and the transmission of the transmission element 115 is required this time (step S62). In a case where the transmission of the transmission element 115 is not required (No in step S62), the transmission element 115 of the ultrasonic sensor 117 is turned off (step S63) and then the reception element 116 of the ultrasonic sensor 117 is made to receive ultrasonic waves to obtain a detection waveform (step S64). The detection waveform thus obtained is compared with the reference waveform of the reference waveform data 106S (step S65). A diagnosis report including a comparison result thereof and the detection waveform is sent to the management server 2001 (step S71). The diagnosis report presents each of pieces of sampling data obtained from the factor-identifying operation, in a manner correlated to an identifier of the image forming apparatus 1000, a count value of the conveyed sheet counter 105C at a timepoint of executing the factor-identifying operation, and a comparison result with the reference waveform data 106. Consequently, a creator of the increase tendency look-up table 106T is urged to review this increase tendency look-up table 106T.

In a case where the transmission and outputting are required (Yes in step S62), the transmission element 115 of the ultrasonic sensor 117 is turned on (step S66), the reception element 116 of the ultrasonic sensor 117 is made to receive ultrasonic waves to obtain a detection signal (step S67). The diagnosis report is created by performing comparison between a detection waveform of this detection signal and the reference waveform of the reference waveform data 106S (step S68). After that, the diagnosis report is sent to the management server 2001 (step S71).

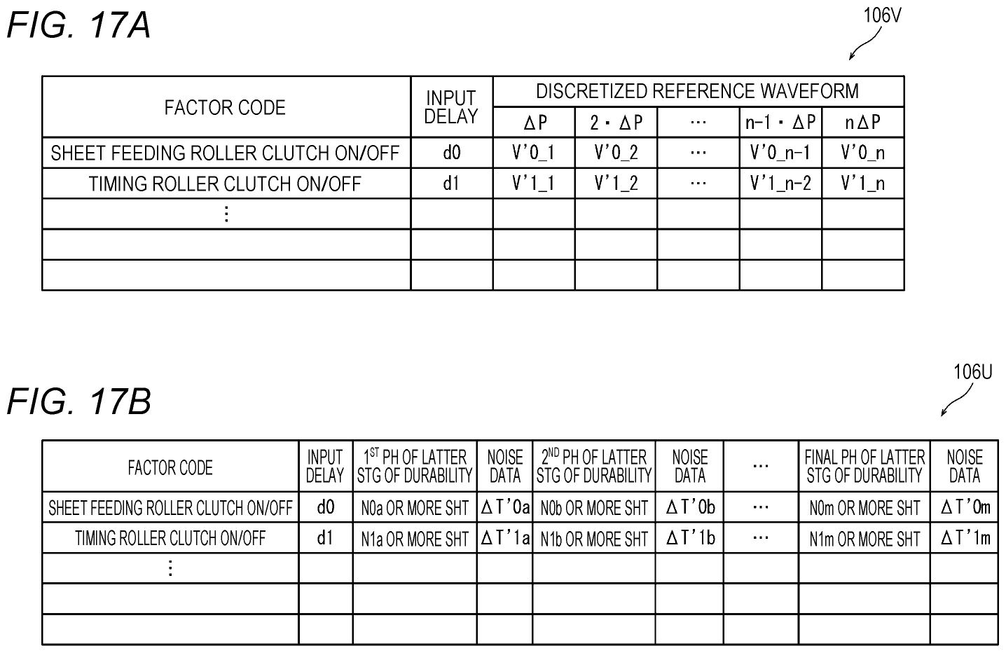

In the waveform comparison in steps S65 and S68, it is possible to clarify, from the comparison between the detection waveform of the ultrasonic sensor 117 and the reference waveform of the reference waveform data 106S, whether or not a noise caused by an unknown noise source not identified with a factor code is superimposed on the detection signal. In the processing of FIG. 16 described above, the reference waveform data 106S illustrated in FIG. 12A of the second embodiment is used as the reference waveform data 106S at the time of having transmission of ultrasonic waves. Separately from this, the reference waveform data 106S at the time of having no transmission of ultrasonic waves is downloaded from the management server 2001 of the public network 2000. FIG. 17A illustrates the reference waveform data 106V at the time of having no transmission of ultrasonic waves. Respective peak values (V′0_1, V′0_2, . . . , V′0_n−2, V′0_n−1) of the reference waveform data 106V at the time of having no transmission ultrasonic waves are set to values different from respective peak values (V0_1, V0_2, . . . , V0_n−2, V0_n−1) of the reference waveform data 106S illustrated in FIG. 12A. Therefore, how much the noise appears due to a factor other than the transmission from the transmission element 115 can be clarified by performing the comparison with the detection signal of the ultrasonic sensor 117 at the time of having no transmission of ultrasonic waves.

(3) In the above modified example, the increase tendency look-up table (increase tendency look-up table 106U) at the time of having no transmission of ultrasonic waves may be a constituent element of the database 106D. FIG. 17B illustrates an exemplary increase tendency look-up table 106U at the time of having no transmission of ultrasonic waves. As illustrated in this drawing, in the increase tendency look-up table 106U at the time of having no transmission of ultrasonic waves, a noise continuation period of noise data corresponding to each of the phases is different from that in the increase tendency look-up table 106T described in the first embodiment.

Additionally, in a case where the self-evaluator 109 causes the reception element 116 to output a detection signal without making the transmission element 115 transmit ultrasonic waves in each of the phases of the latter stage of durability, the self-evaluator 109 executes the self-diagnosis on whether or not any noise waveform of a noise continuation period indicated by the noise data in each of the phases appears in the detection waveform.

Note that an operation mode to execute the factor-identifying operation may be provided in the image forming apparatus 1000, and the factor-identifying operation may be executed at the time of executing the operation mode.

(4) In the adjustment of the increase tendency look-up table 106T by the self-evaluator 109, as for a noise factor clarified to cause no noise as a result of the comparison with the reference waveform data 106S, the increase tendency look-up table 106T may be updated so as to indicate this noise factor does not generate any noise. That is, a flag indicating presence/absence of a noise is added in a manner correlated to each of the factor codes in the increase tendency look-up table 106T of FIG. 5A. This flag is set, by default, to a value indicating a noise (e.g., “1”). However, in a case of finding, from execution of the factor-identifying operation by the self-evaluator 109, that there is a factor code that does not cause any noise among the factor codes of the increase tendency look-up table 106T, an OFF flag (e.g., “0”) is set to a flag correlated to this factor code. Such flag setting is repeated to update the increase tendency look-up table 106T, and then the database 106D including the updated increase tendency look-up table 106T is sent to the management server 2001. Since the updated increase tendency look-up table 106T is sent to the management server 2001, the creator of the database 106D can confirm whether or not the factor assumed by the creator has caused a noise in the actual use of the conveyor 1100.

Furthermore, in a case where various noises are superimposed on a detection signal, it is possible to analyze which one of the roller members provided on the conveyance path is a noise source of which noise. Consequently, it is possible to clarify the relation between a noise superimposed on the detection signal and each roller member, and detailed analysis on the noises can be executed.

(5) In the above modified example, the execution mode of the factor-identifying operation is set on the condition that a sheet type of a currently-selected sheet feeding cassette has been already determined in step S51 of the flowchart of FIG. 15A, but not limited thereto. The execution mode of the factor-identifying operation may be set on the condition that a sheet is not fed from the sheet feeding cassettes 1002a, 1002b, 1002c, and 1002d.

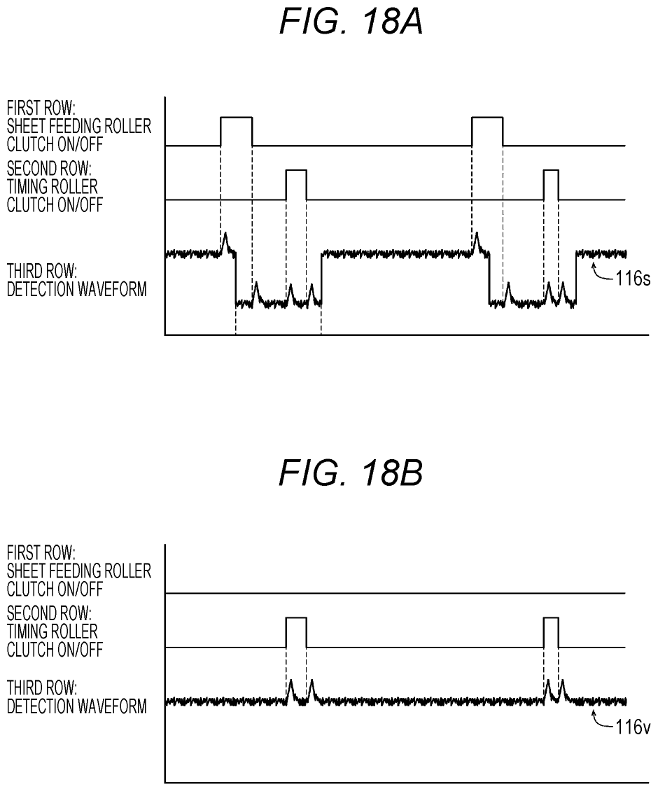

FIG. 18A is a timing chart in a case of executing the factor-identifying operation during sheet feeding, and FIG. 18B is a timing chart in a case of executing the factor-identifying operation during no sheet feeding. In the timing chart of FIG. 18B, as illustrated in a first row, the clutch of the sheet feeding roller 122 is not turned on/off and sheet feeding is not executed. Instead, the clutch of the timing roller 123 is turned on and off. Then, the ultrasonic sensor 117 is made to output a detection signal on which noises generated by clutch on/off of the timing roller 123 are superimposed.

On the other hand, the reference waveform data 106S of the detection signal on which the noises generated by the clutch on/off of the timing roller 123 are superimposed is downloaded from the management server 2001. Respective pieces of sampling data representing a reference waveform during no sheet feeding exhibit voltage values different from voltage values of respective pieces of sampling data representing a reference waveform during the sheet feeding. The self-evaluator 109 compares the reference waveform represented by the reference waveform data 106S with a signal waveform 116V of the detection signal on which the noises generated by the clutch on/off of the timing roller 123 are superimposed.

The pieces of sampling data during no sheet feeding are obtained from the management server 2001, and a diagnosis report is created by comparing the pieces of sampling data with the detection waveform by the ultrasonic sensor 117.

Since the timing roller 123 is rotated alone and the detection signal at the time of this rotation is compared with the reference waveform of the reference waveform data 106S, it is possible to clarify what kinds of noises are superimposed on the detection signal due to vibration caused by the single rotation of the timing roller 123. As for other roller members provided in the conveyance path besides the timing roller 123, single rotation and comparison between a detection signal during the rotation and the reference waveform of the reference waveform data 106S are also performed in a manner similar to the timing roller 123.

By performing such single rotation and such comparison with the reference waveform, it is possible to individually analyze which one of the roller members provided in the conveyance path is a noise source of which noise. Consequently, a causal relation between a noise superimposed on a detection signal and each roller member is clarified, and a noise generated at the time of sheet conveyance through the conveyance path can be analyzed in detail.

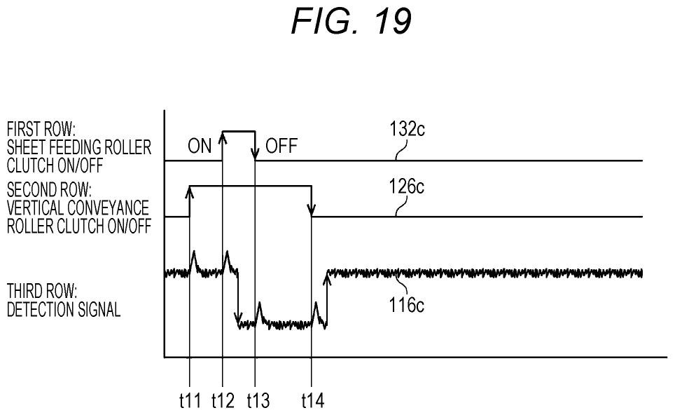

(6) In the above-described embodiments, the noise factors in the example of feeding sheets from the first sheet feeding cassette 1002a have been described, but not limited thereto. As the noise factors in the example of feeding sheets from the second sheet feeding cassette 1002b or another lower sheet feeding cassette, clutch on/off of the sheet feeding roller 132 corresponding to the second sheet feeding cassette, and clutch on/off of the vertical conveyance roller 133 may be specified in the increase tendency look-up table 106T of the database 106D. FIG. 19 illustrates a timing chart of clutch on/off timing of the vertical conveyance roller 133 illustrated in FIG. 3.

Hereinafter, drive control by the mechanical controller 105 in the case of feeding sheets from the second sheet feeding cassette or another lower sheet feeding cassette will be described with reference to FIG. 19. Rotation of the vertical conveyance roller 133 is started at a timepoint t11 slightly earlier than start of rotation of the sheet feeding roller 132 in order to keep a rotation speed constant. The reason is that it is desirable that the vertical conveyance roller is rotated at the constant speed when a nip of the vertical conveyance roller 133 nips a sheet. Then, the clutch of the sheet feeding roller 132 is turned on at a timepoint t12, and the sheet feeding roller 132 feeds a sheet from the second sheet feeding cassette 1002b. The fed sheet is conveyed by the vertical conveyance roller 133 being rotated, and heads to a position of the timing roller 123. Then, the clutch of the sheet feeding roller 132 is turned off at a timepoint t13, and driven rotation of the sheet feeding roller 132 is started. When a leading edge of the sheet arrives at the nip of the timing roller 123, the clutch of the vertical conveyance roller 133 is turned off at a timepoint t14.

A noise waveform caused by the clutch on/off of the sheet feeding roller 132, a noise waveform caused by the clutch on/off of the vertical conveyance roller 133, and a noise waveform caused by the clutch on/off of the timing roller 123 are illustrated in the timing chart, and how these noise waveforms are changed in the respective phases of the latter stage of durability are preliminarily specified in the increase tendency look-up table 106T. Then, when the number of conveyed sheets counted by the conveyed sheet counter 105C reaches the number of conveyed sheets in one of the phases in the increase tendency look-up table 106T, the noise data corresponding to the phase is used to identify start time and end time of a period during which the noise of each of the sheet feeding roller 132 and the vertical conveyance roller 133 appears, and pieces of sampling data corresponding to the period therebetween are removed.

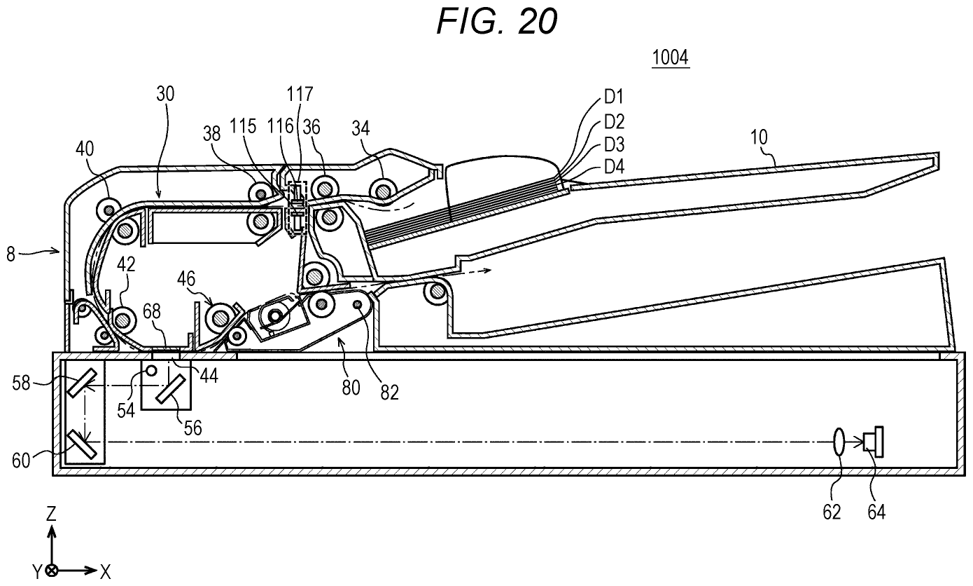

(7) In the above-described embodiments, the transmission element 115 and the reception element 116 constituting the ultrasonic sensor 117 are provided at the upstream position of the timing roller 123, and determine whether or not sheets fed from a sheet feeding cassette are double-fed. On the other hand, in the present modified example, the ultrasonic sensor 117 is provided on a conveyance path of the automatic document feeder 1004 illustrated in FIG. 1, and whether or not documents are double-fed and whether or not a sheet type of the documents is a normal type are determined by the ultrasonic sensor 117. FIG. 20 illustrates internal components of the automatic document feeder 1004. As illustrated in FIG. 20, the automatic document feeder 1004 includes a pickup roller 34 and a separation roller 36. Document sheets D1, D2, D3, and D4 stacked on a tray 10 are fed one by one and sent to a conveyance path 30. The conveyance path 30 includes conveyance rollers 38, 40, 42, 46, and the like, and moves the document sheets D1, D2, D3, and D4 along the conveyance path 30 by rotation of these conveyance rollers, and then makes these document sheets pass through a scan position 44 of a slit glass 68. At the scan position 44, a document sheet is irradiated with light of a light source 54 while a surface of the document is in contact with the slit glass 68. Reflected light thereof is guided to a line sensor 64 through mirrors 56, 58, and 60 and a lens 62.

In the conveyance path 30 of the automatic document feeder 1004 thus configured, the transmission element 115 and the reception element 116 of the ultrasonic sensor 117 are provided at positions between the separation roller 36 and the conveyance roller 38. A housing of the automatic document feeder 1004 is often made from a light resin, and it can be hardly said that the housing is robust. Furthermore, since it is required to install the transmission element 115 and the reception element 116 in the periphery of the conveyance path of the automatic document feeder 1004, a large installation space cannot be secured. Therefore, the reception element has to be installed in the vicinity of the motors or the rollers. When the conveyance rollers 38, 40, 42, and 46 are rotated, the reception element 116 thus installed is affected by vibration caused by the rotation thereof. Accordingly, the noise analyzer 106 calculates the time when a noise is generated and a continuation period of the noise by referring to the increase tendency look-up table 106T, and makes the signal processor 107 execute noise removal in accordance with the calculation results. Consequently, it is possible to perform, in a scan job, determination on double feed of documents read by the automatic document feeder 1004 or determination on the sheet type thereof.

(8) Since the above-described factor-identifying operation by the self-evaluator 109 is intended to monitor actual noise appearance, more detailed noise analysis may also be executed. For example, a detection signal by the reception element may be quantized at a high sampling frequency with a large quantization bit width to represent a detection waveform with pieces of sampling data of a large bit amount. Conversely, a detection signal by the reception element may be quantized at a low sampling frequency with a small quantization bit width to represent a detection waveform with pieces of sampling data of a small bit amount, and simple analysis may be performed.

(9) In step S7 of FIG. 8, when the signal processor 107 removes, from the detection waveform of the ultrasonic sensor 117, pieces of sampling data corresponding to a period during which noises appear, the number of pieces of sampling data runs short by the amount of the removed pieces, and it may be difficult to prepare the number of pieces of sampling data required for the double feed determination. Accordingly, in the present modified example, in a case where a large number of pieces of sampling data are removed due to the noises and the number of pieces of sampling data becomes smaller than the lower limit value required for the double feed determination, a weight is provided to sheet conveyance. Specifically, a sheet conveyance speed is reduced or sheet conveyance is stopped for a necessary time. Then, the number of times of transmission and reception of ultrasonic waves by the transmission element 115 and the reception element 116 is increased.

Even though the pieces of sampling data are thus collected by spending a long time, it is better than making erroneous determination on sheets overlapping. From such an idea, in the present modified example, pieces of sampling data are collected by spending a long time, and determination is made on whether or not the sheets are double-fed.

(10) The conveyed sheet counter 105C in the above-described embodiments uses the number of conveyed sheets that have passed through the conveyance path as a parameter indicating deterioration caused by the use of the conveyor 1100, but not limited thereto. A different value may also be used as a deterioration parameter as far as there is a reasonable causal relation with a reception environment of the ultrasonic sensor 117. Specifically, the time and date when the image forming apparatus 1000 was installed in an office is preliminarily stored, a cumulative use time from start of the use to the current time is calculated, and the cumulative use time may be used as a parameter indicating the deterioration caused by the use of the conveyor 1100. In a case of representing a threshold value N0a in the first phase of the latter stage of durability by using the cumulative use time, it is desirable to set about 1500 hours as the threshold value, for example.

Additionally, a counter that counts the total number of times of rotation in each of the timing roller 123 and the sheet feeding roller 122 existing in the periphery of the reception element may be provided, and a count value of each of the counters may be used as a parameter indicating the deterioration caused by the use of the conveyor 1100. Furthermore, a counter that counts the number of times of job execution by the image forming apparatus 1000 may be provided, and a count value of the counter may be used as a parameter indicating the deterioration caused by the use of the conveyor 1100.

(11) In the above-described embodiments, noises generated at the time of turning on/off a clutch are determined as removal targets. On the other hand, in the present modified example, an electrostatic noise caused by deterioration of static elimination performance in each of the sheet feeding roller 122 and the timing roller 123 is removed. In the latter stage of durability, a minute gap is generated between a roller bearing and a roller shaft due to wear of the roller bearing or the like, and the static elimination function via the housing is deteriorated. When such deterioration of the static elimination function advances, electrostatic noises intrude into a signal line that connects the reception element 116 during rotation of sheet feeding roller 122 and the timing roller 123, and waveforms of electrostatic noises appear in a signal waveform of the detection signal. Therefore, in the present modified example, such electrostatic noises are removed.

The above-described rollers are electrically charged by friction with a sheet, but the electric charge to each of the rollers is naturally eliminated with elapse of a reasonable time from passage of a tailing edge of the sheet at each of the rollers. Therefore, a period for which the signal processor 107 should perform removal of the electrostatic noises is from when a sheet is nipped at each of the nips of the sheet feeding roller 122 and the timing roller 123 until the reasonable time for static elimination has elapsed from the passage of the tailing edge of the sheet at each of these nips. During this period, the signal processor 107 of the present modified example continuously removes the noises from the detection signal output from the ultrasonic sensor 117. The noise removal here can be executed by subtracting a peak value of the electrostatic noise from a peak value indicated by a piece of the sampling data. The removal of the electrostatic noises by such subtraction can improve accuracy of the double feed determination.

(12) Clutch on/off is used as a noise factor, but not limited thereto. Noise factors may include: a noise caused by vibration when a sheet enters the nip of the sheet feeding roller 122 or the nip of the timing roller 123; a noise caused by vibration when a sheet is separated from the nip of the sheet feeding roller 122 or the nip of the timing roller 123; and a noise caused by vibration caused when a sheet forms a loop before each of these nips. In this case, a sheet sensor is provided at a position before each of the nips or a position where the loop is formed.

Additionally, record units in which the factor codes indicating the nip entry, the nip separation, and the loop formation are used as indexes are added to the increase tendency look-up table 106T. Pressure at a nip that nips a sheet and a contact width of the nip are gradually changed over time. Due to such changes, vibration generated at the moment of sheet entry or at the moment of sheet separation are gradually increased. Accordingly, a plurality of pieces of noise data of a noise waveform that is changed in accordance with a degree of aged deterioration is stored in each of the record units corresponding to the factor codes representing the nip entry, the nip separation, and the loop formation, respectively. Additionally, input delays corresponding to these factor codes are stored in the record units. Each of the input delays here corresponds to a delay time from when a sheet is detected by the sheet sensor provided at each of the position before the nips and the loop forming place until vibration/impact actually occurs and a noise is superimposed on the detection signal. Specifically, as for each of the noise factors of the nip entry and the loop formation, the input delay is a time obtained by dividing, by a conveyance speed, a distance from the sheet sensor to the nip of each roller member. As for the noise factor of the nip separation, the input delay is a value obtained by dividing, by the conveyance speed, the distance from the sheet sensor to the nip of each roller member, and adding, to a result thereof, a passage time of the sheet through each nip.

Then, when the sheet sensor detects arrival of the sheet, the signal processor 107 adds each input delay to a notification timepoint, thereby clarifying the time when a noise is superimposed due to each of the nip entry, the nip separation, and the loop formation.

(13) There is a guide member that constitutes a conveyance path and has a curved guide surface. When a leading edge of a straight-moving sheet enters and abuts on such a curved guide surface, a noise may be superimposed on a detection signal of the ultrasonic sensor 117 due to impact of such abutment. A factor code using such a guide surface abutment as a noise factor may be stored in the increase tendency look-up table 106T. In this case, a record unit in which the factor code indicating the guide surface abutment is used as an index is added to the increase tendency look-up table 106T. Here, the guide member is fixed to the apparatus housing by using a fastener such as a screw. However, in a case where fixation by the fastener is loosened over time, the vibration at the time of sheet abutment on the guide member is gradually increased. Accordingly, a plurality of pieces of noise data of a noise waveform changed in accordance with the degree of aged deterioration is preliminarily stored in the record unit in which the factor code of the guide surface abutment is used as the index. Furthermore, a delay time, which is a period from when the sheet sensor in the vicinity detects passage of a leading edge of a sheet until a noise caused by the abutment is superimposed on the detection signal, is stored in the record unit as an input delay. The noise factor of the guide surface abutment sets, as an input delay, a value obtained by: dividing the distance from the sheet sensor to the guide surface by the conveyance speed; and adding, to a result thereof, a passage time during which the sheet passes through a nip.

Thus, the noise analyzer 106 and the signal processor 107 remove the noises superimposed on the detection signal by using the pieces of noise data and the input delay stored in the increase tendency look-up table 106T.

(14) The noise continuation period in each of the phases of the latter stage of durability is specified in the increase tendency look-up table 106T, and the pieces of sampling data corresponding to this noise continuation period are removed, but not limited thereto. A noise peak value in each of the phases of the latter stage of durability may be specified in the increase tendency look-up table 106T, and it is possible to execute processing of subtracting the peak value specified in the increase tendency look-up table 106T from a peak value indicated by a piece of sampling data. Furthermore, the number of pieces of sampling data on which noises are superimposed may be preliminarily specified for each of the phases of the latter stage of durability in the increase tendency look-up table 106T, comparison may be performed between a detection waveform and the waveform reference data, and pieces of the sampling data corresponding to the number of pieces of sampling data in each of the phases in the latter stage of durability may be removed in accordance with the comparison result. Moreover, the number of times of sampling data removal may be increased or decreased in accordance with the comparison result with the reference waveform data 106S.

Additionally, a combination of a noise continuation period and an input delay may be specified for each of the phases in the increase tendency look-up table 106T, or only the input delay may be specified in each of the phases in the increase tendency look-up table 106T. In the increase tendency look-up table 106T, the number of conveyed sheets is correlated to each of the plurality of phases of the latter stage of durability, but not limited thereto. One threshold value that defines the latter stage of durability may be correlated to one piece of noise data.

Furthermore, the signal processor 107 removes, from the detection signal, the pieces of sampling data corresponding to the period from the noise start time to the noise end time notification of which is provided from the noise analyzer 106, but not limited thereto. The pieces of sampling data corresponding to the period from the noise start time to the noise end time may be disregarded, and the double feed determination and the sheet type determination may be executed by using the remaining pieces of sampling data.

Additionally, the increase tendency look-up table 106T illustrated in FIG. 5A has the data structure in which the factor codes are arrayed in the column direction and threshold values of the plurality of numerical ranges of the deterioration degrees are arrayed in the row direction, but not limited thereto. A data structure in which the factor codes are arrayed in the row direction and threshold values of the plurality of numerical ranges of the deterioration degrees are arrayed in the column direction may be used, and each piece of noise data may be stored at a two-dimensional position determined by a position in the column direction and a position in the row direction.

(15) In the above-described embodiments, the reference waveform data 106S is formed by arraying the pieces of sampling data having the peak values quantized, but not limited thereto. The reference waveform data 106S may be formed by using pieces of vector data representing a waveform shape. Furthermore, the reference waveform data 106S may be formed with: a flag that defines whether or not a waveform appears; and a bit string representing the number of waveforms in 2 bits.

The pieces of noise data in the increase tendency look-up table 106T indicate continuation periods, but not limited thereto. In each of the phases of the latter stage of durability, a wavelength, a frequency, and a peak value of a sine wave that is superimposed as a noise on a detection signal of the ultrasonic sensor 117 may be specified. Additionally, the increase tendency look-up table 106T of the first embodiment is used, but not limited to thereto. Instead of the increase tendency look-up table 106T, a table in which a function to derive a noise continuation period from the number of conveyed sheets is correlated to each factor code may be also used for noise removal. Additionally, a noise to be superimposed on a detection signal may be derived by using learning data obtained by deep machine learning.

(16) The ultrasonic sensor 117 of the above-described embodiments has the configuration in which the transmission element 115 and the reception element 116 face each other while interposing the conveyance path therebetween, but not limited thereto. A single piezoelectric element may also serve as both the transmission element 115 and the reception element 116. The ultrasonic sensor 117 having such a configuration performs a function as the transmission element 115 and a function as the reception element 116 in a time sharing manner. In one time unit (slot) of time sharing processing, the ultrasonic sensor 117 transmits an ultrasonic wave toward a sheet conveyed through the conveyance path. In a next slot, the transmitted ultrasonic wave is reflected at a partition wall or the like in the periphery of the conveyance path, and this reflected wave is received. A peak value of the reflected wave thus received has an attenuation amount in accordance with a thickness of the sheet. Therefore, it is possible to determine, by referring to the attenuation amount, whether or not sheets are conveyed in an overlapping manner and whether or not a sheet has a thickness as a plain sheet. Thus, since the double feed determination is performed on the basis of the attenuation amount of the reflected wave, the ultrasonic sensor 117 can have a simpler configuration. The signal processor 107 removes pieces of sampling data as a target, but not limited thereto. The noise removal may be performed by processing (such noise canceler or the like) for analog processing.

(17) In the above-described embodiments, the double feed determination is performed by utilizing the ultrasonic waves, but not limited thereto. The sheet type determination utilizing the ultrasonic waves may also be performed.

Specifically, whether or not a sheet fed from the sheet feeding cassettes 1002a, 1002b, 1002c, and 1002d, or a manual feeding tray 1002h is an envelope may be determined on the basis of peak values of pieces of sampling data. The envelope has a structure in which end portions of two sheets are bonded to each other and an air layer exists between the two sheets. In a case where the ultrasonic sensor 117 transmits an ultrasonic wave at the time of conveying the envelope, a detection signal output from the reception element 116 of the ultrasonic sensor 117 exhibits an attenuation unique to the air layer. Accordingly, the signal processor 107 refers to the peak values of the pieces of sampling data output from the AD converter 208, and determines whether or not there is an attenuation unique to the air layer. Thus, the sheet type determination on whether or not the sheet fed from the sheet feeding cassettes 1002a, 1002b, 1002c, or 1002d is an envelope may be performed.

Besides, whether a sheet fed from the sheet feeding cassette 1002a is a plain sheet having a normal thickness or a thick sheet having a thickness greater than that of the plain sheet may be determined by using the peak values of the pieces of sampling data output from the AD converter 208.

Additionally, a type of conveyed sheet may be identified in detail by using, in combination, detection results of: an optical sensor provided in the conveyance path; and sheet size sensors provided in the sheet feeding cassettes 1002a, 1002b, 1002c, and 1002d. Furthermore, whether or not a flap of an envelope has arrived at an installation position of the ultrasonic sensor 117 may be determined by referring to a detection signal output from the ultrasonic sensor 117. Thus, an arrival timepoint of an end of the envelope may be detected by identifying an arrival timepoint of the flap.

(18) The conveyor 1100 of the above-described embodiments is provided in the image forming apparatus 1000 that is the MFP, but not limited thereto. The conveyor 1100 may be provided in a production printing apparatus. Since the production printing apparatus has a long conveyance path, the ultrasonic sensor 117 is provided at an arbitrary position on the conveyance path. Then, when the ultrasonic sensor 117 installed at the arbitrary position of the conveyance path outputs a detection signal, the noise analyzer 106 and the signal processor 107 may perform, for the detection signal, the noise removal described in the above-described embodiments. Furthermore, the conveyor 1100 may be provided in a single-function peripheral apparatus (printer) of a personal computer. Besides, the conveyor 1100 may be provided in a label printer, a postcard printer, or a ticketing machine.

According to the present invention, it is possible to appropriately perform the double feed determination and the sheet type determination for a sheet on which an image is formed or a sheet to be a target of image reading. Additionally, the present invention is applicable to not only industrial fields of OA equipment and information equipment but also industrial fields of various kinds of business such as retailing business, lease business, real estate business, advertising business, transportation business, and publishing business.

According to an embodiment of the present invention, the look-up table representing the pieces of noise data of noises caused by aged deterioration is searched to obtain a piece of noise data corresponding to the parameter indicating the aged deterioration, and the signal processing such as the double feed determination is applied to the remaining portion of the detection signal of the ultrasonic sensor excluding the portion corresponding to the pieces of noise data. The noises superimposed due to the aged deterioration are excluded from the signal processing. Therefore, in a case where the determination utilizing attenuation of ultrasonic waves, such as the double feed determination, is applied to the detection signal after the noise removal, it is possible to maintain reasonable determination accuracy even though deterioration of the image forming apparatus has advanced in the latter stage of durability. Since troubles relating to the sheet conveyance in the latter stage of durability are prevented in advance, a strong appeal can be made to a user on the stability in sheet determination utilizing ultrasonic waves, such as the double feed determination.

Although embodiments of the present invention have been described and illustrated in detail, the disclosed embodiments are made for purposes of illustration and example only and not limitation. The scope of the present invention should be interpreted by terms of the appended claims.

What is claimed is:

1. A conveyor that conveys a sheet along a conveyance path provided with an ultrasonic sensor, the conveyor comprising:
an updating member that successively updates a parameter indicating aged deterioration of the conveyor;
a searcher that searches a look-up table storing pieces of noise data of noises predicted to be superimposed on a detection signal of the ultrasonic sensor in accordance with a degree of the aged deterioration, and obtains a piece of noise data corresponding to a current parameter value of the conveyor; and
a signal processor that uses, for signal processing, a remaining portion of the detection signal of the ultrasonic sensor excluding a portion corresponding to the piece of noise data obtained by the searcher.

2. The conveyor according to claim 1, wherein
the look-up table has a structure in which a plurality of noise factors that may occur during sheet conveyance is arrayed in a row direction or a column direction which is a first direction, and a plurality of threshold values of a value which the parameter may take is arrayed in the column direction or the row direction that is a second direction,
in the look-up table, a two-dimensional position is determined by a position in the first direction and a position in the second direction and designated by a combination of a noise factor and a parameter value, and each piece of noise data predicted to be generated is stored in the two-dimensional position relative to the combination of a noise factor and a parameter value, and
when one of the noise factors arranged in the first direction occurs, the searcher reads a piece of noise data stored at the two-dimensional position defined by a position in the first direction corresponding to the occurring noise factor and a position in the second direction corresponding to a current parameter value of the updating member.

3. The conveyor according to claim 2, wherein
each piece of the noise data in the look-up table indicates a continuous time length representing a continuous period of a noise superposition caused by the noise factor corresponding to the position in the first direction of the look-up table, and
when the noise factor occurs and the piece of noise data is read from the look-up table, the signal processor designates a range of a portion to be removed from the signal processing on a basis of an occurrence timepoint of the noise factor and the continuous time length indicated by the read piece of noise data.

4. The conveyor according to claim 3, further comprising:
a drive source; and
a clutch that switches, between an engaged state and a disengaged state, a rotary shaft of the drive source and a rotary shaft of a roller member, wherein
the look-up table specifies a switching command for the clutch as a noise factor.

5. The conveyor according to claim 4, wherein
the look-up table further stores delay information in a manner correlated to each noise factor, and the delay information indicates a delay time that is a period from when switching of the clutch is commanded until a noise is superimposed on the detection signal, and
when the switching command of the clutch is issued, the signal processor determines, as a start point of a portion to be removed from the signal processing, a timepoint at which the delay time indicated by the delay information correlated to the noise factor has elapsed from a timepoint of issuance of the switching command.

6. The conveyor according to claim 3, wherein
the look-up table specifies, as noise factors, entry of a sheet into a nip of the roller member provided on the conveyance path, and/or separation of a sheet from the nip of the roller member.

7. The conveyor according to claim 3, wherein
the conveyance path includes a guide member having a curved guide surface, and
the noise factor indicates entry of a sheet into the curved guide surface as a noise factor.

8. The conveyor according to claim 6, wherein
the look-up table further stores delay information in a manner correlated to each noise factor, and the delay information indicates a delay time from when a sheet sensor provided on the conveyance path detects arrival of a sheet until a noise is superimposed on the detection signal, and
when the sheet sensor detects the arrival of the sheet, the signal processor determines, as a start point of a portion to be removed from the signal processing, a timepoint at which the delay time indicated by the delay information correlated to the noise factor has elapsed from a timepoint the detection.

9. The conveyor according to claim 3, further comprising
an evaluator that evaluates whether or not a noise superimposed on a detection signal of the ultrasonic sensor is appropriate according to a degree of the aged deterioration indicated by the parameter, wherein
in a case where the noise superimposed on the detection signal is not appropriate considering the degree of the aged deterioration indicated by the parameter, the signal processor weights, with a predetermined weighting factor, a continuous time length indicated by each piece of noise data in the look-up table, and then defines the continuous time length as a length of a portion to be removed from the signal processing.

10. The conveyor according to claim 9, wherein
the detection signal is applied with processing by the signal processor after being converted into a plurality of pieces of discrete sampling data by quantization, and
each piece of noise data in the look-up table indicates the continuous time length in accordance with a time length or number of pieces of the sampling data.

11. The conveyor according to claim 3, wherein
the signal processor monitors whether or not a parameter updated by the updating member has reached one of the threshold values arrayed in the second direction of the look-up table, and when the parameter reached one of the threshold values, the signal processor designates a range of a portion to be removed from the detection signal.

12. The conveyor according to claim 11, further comprising
an evaluator that evaluates whether or not a noise superimposed on a detection signal of the ultrasonic sensor is appropriate according to a degree of the aged deterioration indicated by the parameter, wherein
in a case where the noise superimposed on the detection signal is not appropriate considering the degree of the aged deterioration indicated by the parameter, the signal processor sets, as an execution requirement to execute designation of the range, a condition that the parameter updated by the updating member has reached a threshold value weighted with the predetermined weighting factor.

13. The conveyor according to claim 9, wherein
the look-up table further includes state reproduction data that reproduces a signal waveform in a state where a noise amount appropriate according to a degree of aged deterioration indicated by the parameter is superimposed,
the evaluator determines appropriateness of a noise amount superimposed on the detection signal by performing comparison between the signal waveform reproduced by the state reproduction data and a detection signal output from the ultrasonic sensor, and
the predetermined weighting factor is increased/decreased in accordance with the noise amount superimposed on the detection signal.

14. The conveyor according to claim 13, wherein the evaluator further detects whether or not a noise caused by each noise factor appears by performing comparison between a signal waveform of a detection signal output from the ultrasonic sensor and a reproduction waveform reproduced by the state reproduction data, and the evaluator clearly indicates, on the look-up table, presence/absence of a noise caused by each noise factor.

15. The conveyor according to claim 13, wherein
when processing not requiring sheet conveyance is performed in the image forming apparatus including the conveyor, the evaluator causes the ultrasonic sensor to output a detection signal to be compared with the signal waveform reproduced by the state reproduction data.

16. The conveyor according to claim 13, further comprising
a drive source that applies conveyance force to a sheet by rotating the roller member provided on the conveyance path,
wherein the image forming apparatus including the conveyor has an operation mode by which the drive source drives the roller member without performing image formation, and the evaluator causes, in the operation mode, the ultrasonic sensor to output a detection signal to be compared with the signal waveform reproduced by the state reproduction data.

17. The conveyor according to claim 13, wherein
the state reproduction data reproduces a signal waveform of a detection signal output from the ultrasonic sensor in a state where the ultrasonic sensor does not transmit any ultrasonic wave, and
the evaluator obtains a detection signal from the ultrasonic sensor in the state where the ultrasonic sensor does not transmit any ultrasonic wave, and compares a signal waveform of the obtained detection signal with the signal waveform reproduced by the state reproduction data.

18. The conveyor according to claim 1, wherein
the detection signal is applied with processing by the signal processor after being converted into a plurality of pieces of discrete sampling data by quantization, and
in a case where number of remaining pieces of sampling data is greater than predetermined number although the pieces of sampling data corresponding to the noise data are removed, the signal processor executes the signal processing.

19. The conveyor according to claim 18, wherein
in a case where the number of remaining pieces of sampling data is smaller than the predetermined number as a result of removing pieces of sampling data corresponding to a signal portion on which a noise is superimposed, the signal processor increases: a transmission/reception period of ultrasonic waves by the ultrasonic sensor; and the number of pieces of sampling data acquired by a quantizer.

20. The conveyor according to claim 18, wherein
the signal processing includes double feed determination to determine, by using the remaining pieces of the sampling data, whether a single sheet conveyed without overlapping passes through a detection position detected by the ultrasonic sensor or two or more sheets are fed in an overlapping manner.

21. The conveyor according to claim 18, wherein
the signal processing includes sheet type determination to determine, on a basis of the remaining pieces of the sampling data, whether a type of a sheet passing through the detection position detected by the ultrasonic sensor is a plain sheet or a special sheet having a thickness greater than a thickness of the plain sheet.

22. The conveyor according to claim 19, wherein
in a case where a cumulative sampling time is greater than a predetermined upper limit as a result of increasing the transmission/reception period of the ultrasonic waves and the number of acquired pieces of the sampling data, the signal processor notifies an operator of such a fact.

23. The conveyor according to claim 1, wherein
the updating member is a counter that counts total number of sheets conveyed through the conveyance path or number of times of job execution by the image forming apparatus including the conveyor.

24. The conveyor according to claim 1, wherein
the updating member is a timekeeper that performs timekeeping of a total elapse time from start of using the image forming apparatus including the conveyor.
